(19) United States
(12) Patent Application Publication
(10) Pub. No.: US 2023/0243950 A1
(43) Pub. Date: Aug. 3, 2023

(54) SIGNAL PROCESSING DEVICE, SIGNAL PROCESSING METHOD, AND PROGRAM

(71) Applicant: SONY SEMICONDUCTOR SOLUTIONS CORPORATION, KANAGAWA (JP)

(72) Inventor: HARUYOSHI YONEKAWA, KANAGAWA (JP)

(21) Appl. No.: 17/998,533

(22) PCT Filed: Apr. 14, 2021
(86) PCT No.: PCT/JP2021/015387

§ 371 Date: Nov. 11, 2022

(30) Foreign Application Priority Data
May 25, 2020 (JP) 2020-090326

(51) Int. Cl. G01S 13/42; G01S 13/58

(52) U.S. Cl. CPC G01S 13/42; G01S 13/58

(57) ABSTRACT

An apparatus and a method for performing azimuth angle estimation are realized in which an object region or only an object region of a specific type is used as an azimuth angle estimation target region. There are provided: an azimuth angle estimation region selection unit configured to be inputted with a speed-range map indicating a distance and a relative speed of an object having reflected a radar wave, and select an azimuth angle estimation target region from the inputted speed-range map; and an azimuth angle estimation unit configured to execute azimuth angle estimation for only a selected region. The azimuth angle estimation region selection unit detects, from the speed-range map, a cluster that is an aggregate of bright spots and satisfies a predetermined condition, and selects the detected cluster as the azimuth angle estimation target region. For example, an aggregate of bright spots of a prescribed number or more and a prescribed density or more or a cluster corresponding to a specific object type is selected as the azimuth angle estimation target region.

### TECHNICAL FIELD

The present disclosure relates to a signal processing device, a signal processing method, and a program. More specifically, the present disclosure relates to a signal processing device, a signal processing method, and a program for executing an object detection process using radar.

### BACKGROUND ART

For example, a mobile device such as an automated vehicle or a robot detects an object that becomes an obstacle in a traveling direction, and travels while securing a safe traveling route.

Radar is often used for the object detection process.

A general process of a processing technique of object detection by radar is a process of calculating a distance and a direction of each object by using radar.

For example, Patent Document 1 (Japanese Patent Application Laid-Open No. 2010 054344) and the like describe a process of calculating a distance and a direction of each object by using radar.

However, the process of calculating the direction (azimuth angle) of the object has a large processing cost, and there is a problem that a processing delay is likely to occur.

In a robot or an automated vehicle that travels at a high speed, such a processing delay is critical and may cause an accident such as collision with an obstacle.

### CITATION LIST

### Patent Document

Patent Document 1: Japanese Patent Application Laid-Open No. 2010-054344

### SUMMARY OF THE INVENTION

### Problems to be Solved by the Invention

The present disclosure is to solve such a problem, and an object thereof is to provide a signal processing device, a signal processing method, and a program for efficiently executing a process of calculating a direction (azimuth angle) of an object and performing object detection and analysis with a reduced delay.

### Solutions to Problems

A first aspect of the present disclosure is a signal processing device including:

an azimuth angle estimation region selection unit configured to be inputted with a speed-range map indicating a distance and a relative speed of an object having reflected a radar wave, and select an azimuth angle estimation target region from the inputted speed-range map; and

an azimuth angle estimation unit configured to execute azimuth angle estimation for a selected region selected by the azimuth angle estimation region selection unit.

Moreover, a second aspect of the present disclosure is:

a signal processing method to be executed in a signal processing device, the signal processing method being for execution of:

an azimuth angle estimation region selection step, by an azimuth angle estimation region selection unit, of being inputted with a speed-range map indicating a distance and a relative speed of an object having reflected a radar wave, and selecting an azimuth angle estimation target region from the inputted speed-range map; and

an azimuth angle estimation step, by an azimuth angle estimation unit, of executing azimuth angle estimation for a selected region selected in the azimuth angle estimation region selection step.

Moreover, a third aspect of the present disclosure is

a program for causing a signal processing device to execute signal processing, the program causing execution of:

an azimuth angle estimation region selection step of causing an azimuth angle estimation region selection unit to be inputted with a speed-range map indicating a distance and a relative speed of an object having reflected a radar wave, and to select an azimuth angle estimation target region from the inputted speed-range map; and

an azimuth angle estimation step of causing an azimuth angle estimation unit to execute azimuth angle estimation for a selected region selected in the azimuth angle estimation region selection step.

Note that the program of the present disclosure is, for example, a program that can be provided by a storage medium or a communication medium that provides a variety of program codes in a computer-readable format, to an information processing apparatus or a computer system capable of executing the program codes. By providing such a program in a computer-readable format, processing corresponding to the program is realized on the information processing apparatus or the computer system.

Still other objects, features, and advantages of the present disclosure will become apparent from the more detailed description based on the embodiments of the present disclosure as described later and the attached drawings. Note that a system in this specification is a logical set configuration of a plurality of devices, and is not limited to one in which a device of each configuration is in a same casing.

According to the configuration of an embodiment of the present disclosure, an apparatus and a method for performing azimuth angle estimation are realized in which an object region or only an object region of a specific type is used as an azimuth angle estimation target region.

Specifically, for example, there are provided: an azimuth angle estimation region selection unit configured to be inputted with a speed-range map indicating a distance and a relative speed of an object having reflected a radar wave, and select an azimuth angle estimation target region from the inputted speed-range map; and an azimuth angle estimation unit configured to execute azimuth angle estimation for only a selected region. The azimuth angle estimation region selection unit detects, from the speed-range map, a cluster that is an aggregate of bright spots and satisfies a predetermined condition, and selects the detected cluster as the azimuth angle estimation target region. For example, an aggregate of bright spots of a prescribed number or more and a prescribed density or more or a cluster corresponding to a specific object type is selected as the azimuth angle estimation target region.

According to configuration, an apparatus and a method for performing azimuth angle estimation are realized in which an object region or only an object region of a specific type is used as the azimuth angle estimation target region.

Note that the effects described in this specification are merely examples and are not limited, and additional effects may be present.

### BRIEF DESCRIPTION OF DRAWINGS

FIG. 1 is a view for explaining a signal transmission/reception configuration example of a radar device.

FIG. 2 is a view for explaining an azimuth angle.

FIG. 3 is a view for explaining an azimuth angle.

FIG. 4 is a diagram for explaining a configuration example of a general signal processing device (millimeter wave radar device).

FIG. 5 is a view for explaining a speed-range map.

FIG. 6 is a view for explaining an azimuth (azimuth angle) range map.

FIG. 7 is a view for explaining a processing example of an azimuth angle estimation unit.

FIG. 8 is a diagram for explaining a configuration example of a signal processing device (millimeter wave radar device) of the present disclosure.

FIG. 9 is a diagram for explaining a configuration and processing of an azimuth angle estimation region selection unit.

FIG. 10 is a view for explaining processing executed by a clustering processing unit.

FIG. 11 is a view for explaining processing executed by a selected-region-limited azimuth angle estimation unit.

FIG. 12 is a flowchart illustrating a processing sequence executed by the azimuth angle estimation region selection unit of the signal processing device (millimeter wave radar device) of the present disclosure.

FIG. 13 is a diagram for explaining a configuration example of a signal processing device (millimeter wave radar device) of a second embodiment of the present disclosure.

FIG. 14 is a diagram for explaining a configuration and processing of an azimuth angle estimation object selection unit of the second embodiment.

FIG. 15 is a view for explaining processing executed by the clustering processing unit.

FIG. 16 is a view for explaining processing executed by a selected-object-limited azimuth angle estimation unit.

FIG. 17 is a flowchart illustrating a processing sequence executed by an azimuth angle estimation region selection unit of the signal processing device (millimeter wave radar device) of the second embodiment of the present disclosure.

FIG. 18 is a view for explaining a specific processing example in a case where an azimuth angle estimation target object is a vehicle.

FIG. 19 is a view for explaining a specific processing example in a case where an azimuth angle estimation target object is a vehicle.

FIG. 20 is a view for explaining a specific processing example in a case where an azimuth angle estimation target object is a vehicle.

FIG. 21 is a view for explaining a specific processing example in a case where an azimuth angle estimation target object is a vehicle.

### MODE FOR CARRYING OUT THE INVENTION

Hereinafter, details of a signal processing device, a signal processing method, and a program of the present disclosure will be described with reference to the drawings. Note that the description will be made in accordance with the following items.

1. About outline of object detection process using radar

2. About configuration of general signal processing device that executes object detection using radar

3. (First embodiment) about configuration and processing of signal processing device of present disclosure

4. (Second embodiment) about configuration and processing of signal processing device that executes azimuth angle estimation for only object of specific type

5. About generation processing example for azimuth angle estimation object selection speed-range map in case where azimuth angle estimation process target object is vehicle

6. Summary of configuration of present disclosure

### 1. About Outline of Object Detection Process Using Radar

First, an outline of an object detection process using radar will be described.

As described above, for example, a mobile device such as an automated vehicle or a robot detects an object that becomes an obstacle in a traveling direction, and travels while securing a safe traveling route.

Radar is often used for the object detection process.

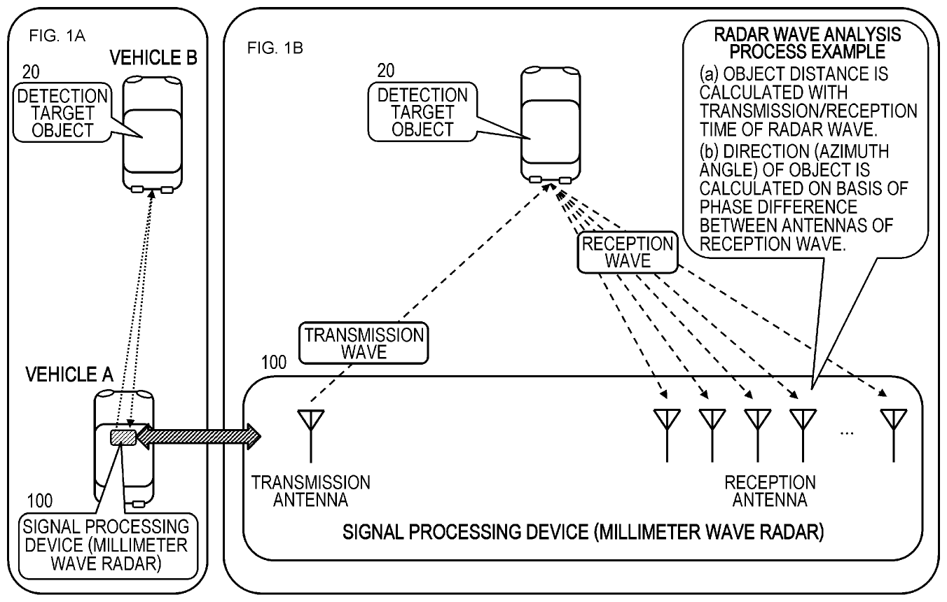

FIG. 1 is a view for explaining an outline of the object detection process using radar.

FIG. 1(1) illustrates a state in which a vehicle A equipped with radar detects a vehicle B in front by using the radar.

FIG. 1(2) is a view illustrating details of a transmission/reception configuration of the radar.

Note that, as the radar that executes the object detection process, for example, millimeter wave radar of 30 to 300 GHz band with a wavelength in units of mm is widely used. The millimeter wave radar has many advantages such as high straightness, easiness of securing a wide bandwidth, high resistance to environmental changes, and a large information amount, and is widely used.

A signal processing device of the present disclosure described below will also be described as a signal processing device using the millimeter wave radar.

However, without limiting to the millimeter wave radar, the signal processing device of the present disclosure may have a configuration using radar of other wavelength bands.

FIG. 1(2) is a view for explaining a process in which a signal processing device (millimeter wave radar) 100 of the vehicle A in FIG. 1(1) detects a distance and a direction (azimuth angle) of the vehicle B in front.

As illustrated in FIG. 1(2), when a transmission wave outputted from a transmission antenna of the signal processing device (millimeter wave radar) 100 reaches the vehicle B, that is, a detection target object 20, the transmission wave is reflected by the vehicle B and received by a plurality of reception antennas of the signal processing device (millimeter wave radar) 100.

The signal processing device (millimeter wave radar) 100 has a plurality of (for example, n pieces of) reception antennas. Since installation positions of the plurality of reception antennas are different from each other, reception timings of reception waves are shifted. That is, the individual reception antennas receive reception waves having different phases.

By a radar wave analysis process with the signal processing device (millimeter wave radar) 100 having such a configuration, a distance and a direction (azimuth angle) of the detection target object 20 are analyzed. Specifically, as illustrated in FIG. 1(2), the following processing is performed.

(a) An object distance is calculated with a transmission/reception time of a radar wave.

(b) A direction (azimuth angle) of the object is calculated on the basis of a phase difference between antennas of the reception wave.

Note that the azimuth angle of the object is an angle between a predefined reference line extending from the signal processing device (millimeter wave radar) 100 and a straight line connecting the signal processing device (millimeter wave radar) 100 and the object. Specifically, the azimuth angle is, for example, with a straight traveling direction of the vehicle A as a reference line (0°), an angle between the reference line and a straight line connecting the vehicle A and the object (the vehicle B).

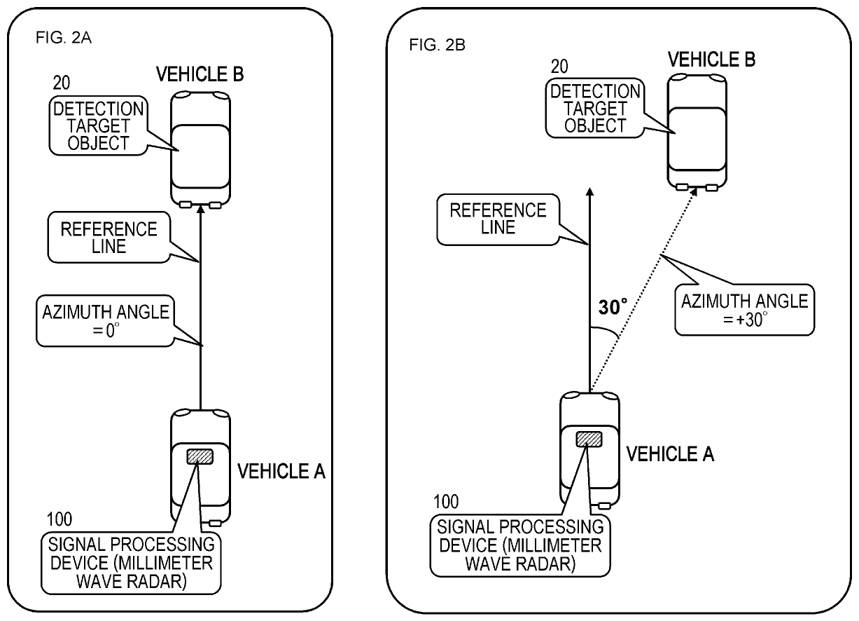

As illustrated in FIG. 2(1), in a case where the reference line is set in a straight forward direction of the vehicle A equipped with the signal processing device (millimeter wave radar) 100, if the vehicle B, that is, the detection target object 20 is on this reference line, the azimuth angle of the vehicle B, that is, the detection target object 20 is 0°.

Furthermore, as illustrated in FIG. 2(2), if the vehicle B, that is, the detection target object 20 is in a direction of an angle of 30° on a right side from the reference line, the azimuth angle of the vehicle B, that is, the detection target object 20 is +30°.

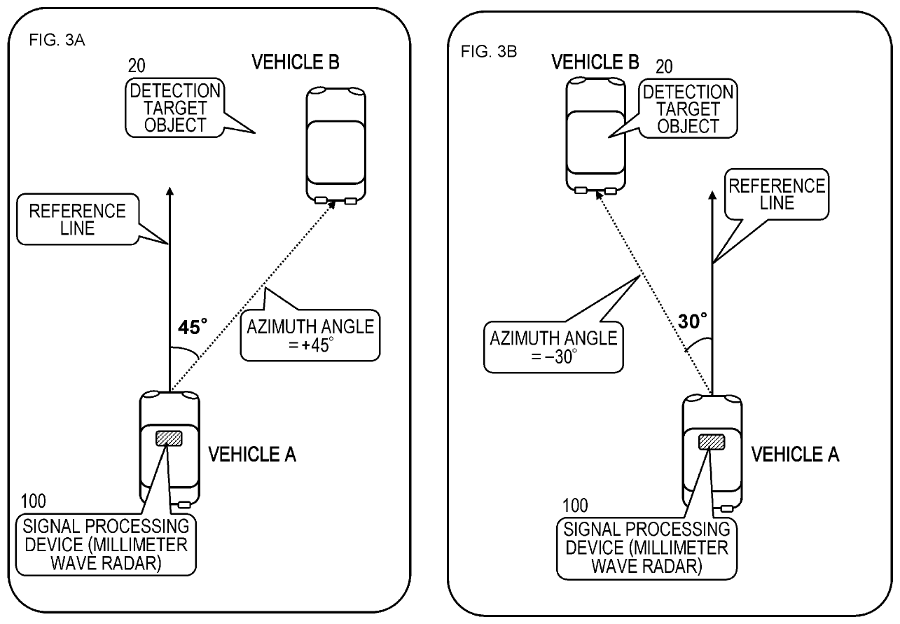

Furthermore, as illustrated in FIG. 3(3), if the vehicle B, that is, the detection target object 20 is in a direction of an angle of 45° on a right side from the reference line, the azimuth angle of the vehicle B, that is, the detection target object 20 is +45°.

Furthermore, as illustrated in FIG. 3(4), if the vehicle B, that is, the detection target object 20 is in a direction of an angle of 30° on a left side from the reference line, the azimuth angle of the vehicle B, that is, the detection target object 20 is −30°.

### 2. About Configuration of General Signal Processing Device that Executes Object Detection Using Radar

Before describing the signal processing device of the present disclosure, a configuration of a general signal processing device that executes object detection using radar will be described.

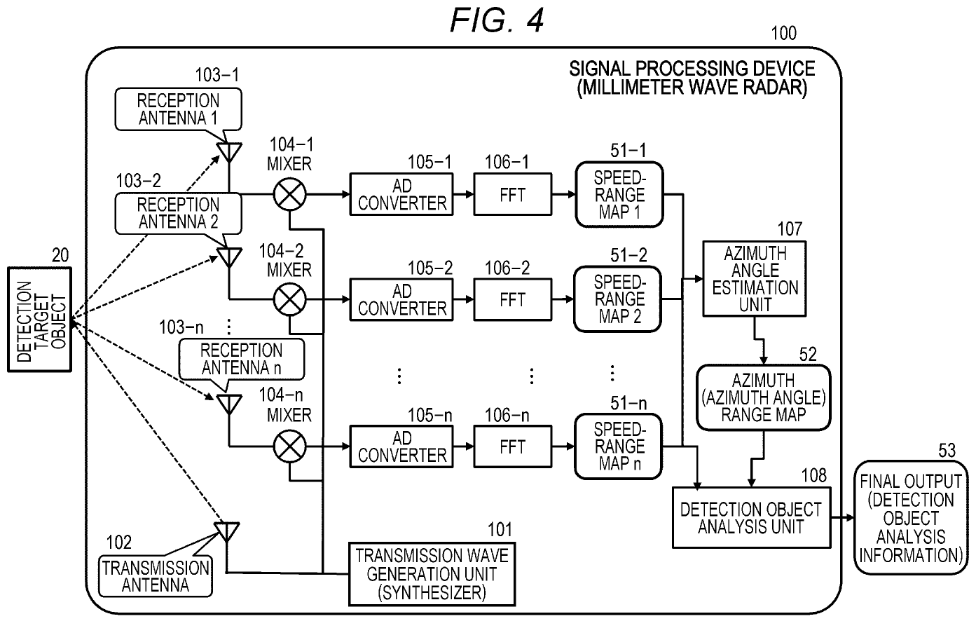

FIG. 4 is a diagram illustrating a configuration example of a conventional signal processing device (millimeter wave radar device) 100.

The signal processing device (millimeter wave radar device) 100 illustrated in FIG. 4 includes, a transmission wave generation unit (synthesizer) 101, a transmission antenna 102, a plurality of (n pieces of) reception antennas 103-1 to n, a plurality of (n pieces of) mixers 104-1 to n for the individual reception antennas, AD converters 105-1 to n, FFTs 106-1 to n, an azimuth angle estimation unit 107, and a detection object analysis unit 108.

The transmission wave generation unit (synthesizer) 101 generates a millimeter wave radar signal to be transmitted via the transmission antenna 102.

As described above, the millimeter wave radar signal is a radar signal of a 30 to 300 GHz band with a wavelength in units of mm. The millimeter wave radar has many advantages such as high straightness, easiness of securing a wide bandwidth, high resistance to environmental changes, and a large information amount.

The millimeter wave radar signal generated by the transmission wave generation unit (synthesizer) 101 is transmitted via the transmission antenna 102.

The millimeter wave radar signal transmitted via the transmission antenna 102 is reflected by various objects and received by the plurality of (n pieces of) reception antennas 103-1 to n.

Note that, the figure illustrates an example of a reflected wave of only one detection target object 20, but in practice, reflected waves from a large number of various objects are received by the plurality of (n pieces of) reception antennas 103-1 to n.

The plurality of (n pieces of) reception antennas 103-1 to n is set at different positions as described above with reference to FIG. 1. Therefore, even if the reflection position of the detection target object 20 is the same, reception signals of the plurality of (n pieces of) reception antennas 103-1 to n are signals having different phases.

The reception signals of the plurality of (n pieces of) reception antennas 103-1 to n is respectively inputted to the mixers 104-1 to n in a subsequent stage.

The mixers 104-1 to n calculate difference signals between the reception signals of the individual reception antennas 103-1 to n and the transmission signal generated by the transmission wave generation unit (synthesizer) 101.

The difference signals generated by the mixers 104-1 to n are inputted to the AD converters 105-1 to n, to be converted into digital signals. The digital signal indicates a difference between the reception signal of each of the reception antennas 103-1 to n and the transmission signal generated by the transmission wave generation unit (synthesizer) 101.

The digital signals generated by the AD converters 105-1 to n are respectively inputted to the FFTs 106-1 to n in a subsequent stage.

The FFTs 106-1 to n each perform fast Fourier transform on the digital signals generated by the AD converters 105-1 to n, and perform a signal conversion process of converting a time domain signal into a frequency domain signal.

The FFTs 106-1 to n each execute the fast Fourier transform (FFT) process on the digital signals generated by the AD converters 105-1 to n, and output speed-range maps 51-1 to n as illustrated in the figure.

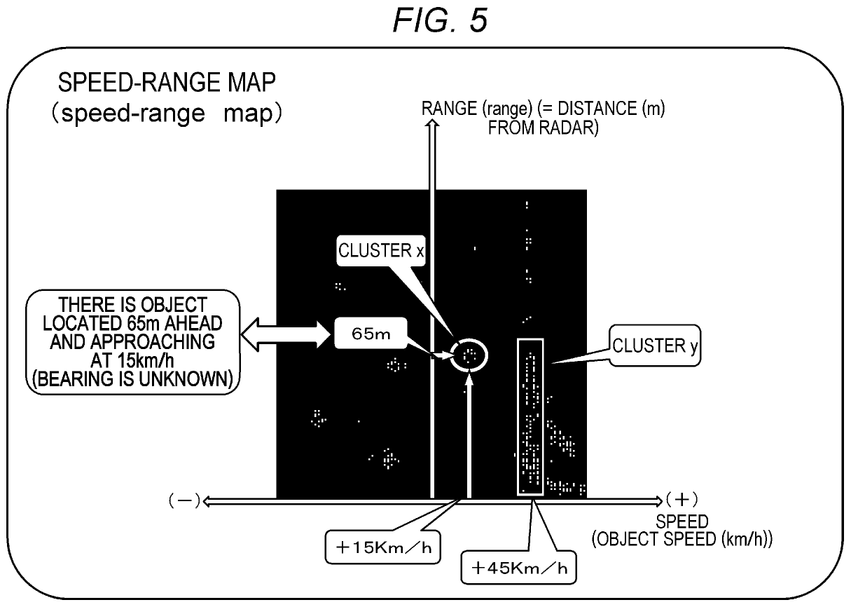

With reference to FIG. 5, a specific example of the speed-range map 51 outputted by an FFT 106 will be described.

As illustrated in FIG. 5, the speed-range map is a map having:

a speed (a relative speed with the signal processing device (radar)) of an object on a horizontal axis; and

a distance (a distance from the signal processing device (radar)) to the object on a vertical axis, and

values of these are set as orthogonal axes.

Note that the object is an object having reflected a radar wave.

A bright spot (white point) on the map illustrated in the figure is to be a point indicating a speed (Km/h) and a distance (m) of the detection object.

Note that each one of the bright spots is (a speed and a distance) based on one reflection unit of an object calculated on the basis of a transmission/reception signal of the radar, and an aggregate (cluster) of a plurality of bright spots is formed in a case where the object is a car, for example.

If the object is large, a large cluster, which is an aggregate of more bright spots, is formed.

For example, a cluster x illustrated in the figure is a cluster having such distance and speed characteristics of:

object distance=65 m, and

object speed=+15 km/h.

This cluster x is an object that is located 65 m ahead and approaching at 15 km/h. From such cluster characteristics, it is possible to estimate that the cluster x is a front vehicle traveling at a speed lower by 15 km than that of the own vehicle equipped with the signal processing device 100.

Furthermore, a cluster y is a cluster having such distance and speed characteristics of:

object distance=0 to 65 m, and

object speed=+45 km/h.

This cluster y is an object continuously present 0 to 65 m ahead and approaching at 45 km/h. From such cluster characteristics, it is possible to estimate that the cluster y is a side wall of a traveling path of the own vehicle (traveling at 45 km/h) equipped with the signal processing device 100.

Note that, from this speed-range map, only the distance and the speed (relative speed) of the detection object can be acquired, and a direction (azimuth angle) of the detection object cannot be acquired.

As illustrated in FIG. 4, the plurality of (n pieces of) FFTs 106-1 to n each performs the fast Fourier transform (FFT) process based on the digital signals indicating a difference between the reception signals of the reception antennas 103-1 to n each and the transmission signal generated by the transmission wave generation unit (synthesizer) 101, and output the plurality of (n pieces of) speed-range maps 51-1 to n. The plurality of (n pieces of) speed-range maps 51-1 to n is inputted to the azimuth angle estimation unit 107.

The azimuth angle estimation unit 107 uses the plurality of (n pieces of) speed-range maps 51-1 to n, that is, the plurality (n) of speed-range maps 51-1 to n generated by the fast Fourier transform (FFT) based on the digital signals indicating a difference from the transmission signal generated by the transmission wave generation unit (synthesizer) 101, to estimate a direction (azimuth angle) of the detection object.

The azimuth angle estimation unit 107 generates one azimuth (azimuth angle) range map 52 through an azimuth angle estimation process for an object by using the plurality of (n pieces of) speed-range maps 51-1 to n.

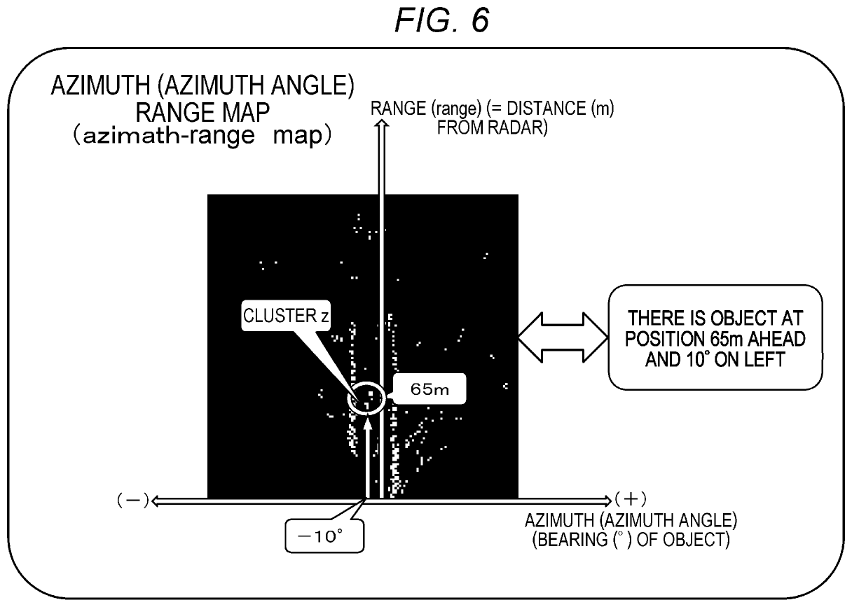

A specific example of the azimuth (azimuth angle) range map 52 generated by the azimuth angle estimation unit 107 is illustrated in FIG. 6.

As illustrated in FIG. 6, the azimuth (azimuth angle) range map is a map having:

an azimuth angle (an angle (bearing) indicating an object direction) of an object on a horizontal axis; and

a distance (a distance from the signal processing device (radar)) to the object on a vertical axis, and

values of these are set as orthogonal axes.

Note that the object is an object having reflected a radar wave.

A bright spot (white point) on the map illustrated in the figure is to be a point indicating an azimuth angle (°) and a distance (m) of the detection object.

Note that each one of the bright spots is a (an azimuth angle and a distance) based on one reflection unit of an object calculated on the basis of a transmission/reception signal of the radar, and an aggregate (cluster) of a plurality of bright spots is set in a case where the object is a car, for example, similarly to the speed-range map described above with reference to FIG. 5.

For example, a cluster z illustrated in FIG. 6 is a cluster having such a distance and an azimuth angle of:

object distance=65 m, and

object azimuth angle=−10°.

From the azimuth (azimuth angle) range map, it can be analyzed that the cluster z is a cluster corresponding to an object that is 65 m ahead and is at a position of an azimuth angle of −10°.

In this manner, the azimuth angle estimation unit 107 generates the azimuth (azimuth angle) range map enabling analysis of the azimuth angle and the distance of the object.

The azimuth (azimuth angle) range map generated by the azimuth angle estimation unit 107 is inputted to the detection object analysis unit 108.

Moreover, the speed-range maps 51-1 to n generated by the FFTs 106-1 to n each are also inputted to the detection object analysis unit 108.

The detection object analysis unit 108 executes an object analysis process using these maps. For example, by executing the object analysis process as to what each cluster that is an aggregate of bright spots and is detected from each map is, such as, for example, a car, a person, a wall, or a pole, a final output (detection object analysis information) 53 is outputted.

For example, the cluster z detected from the azimuth (azimuth angle) range map illustrated in FIG. 6 is a cluster having such a distance and an azimuth angle of:

object distance=65 m, and

object azimuth angle=−10°.

This cluster z is a cluster corresponding to an object located 65 m ahead and at a position of an azimuth angle of −10°.

This cluster z is at the same distance as the cluster x detected from the speed-range map described above with reference to FIG. 5, it is possible to estimate cluster z=cluster x, and this cluster z is estimated to be the same cluster as the cluster x.

As a result, on the basis of this estimation of cluster x=cluster z, it is possible to estimate that

the cluster x (=the cluster z) is a cluster having such cluster characteristics of

object distance=65 m,

object azimuth angle=−10°, and

object speed=+15 km/h, and

it can be estimated that this cluster x (=the cluster z) is a vehicle traveling 65 m ahead of the own vehicle equipped with the signal processing device 100, at a position of an object azimuth angle=−10° and at a speed lower by 15 km than that of the own vehicle.

In this manner, the detection object analysis unit 108 executes the object analysis process using the speed-range map and the azimuth (azimuth angle) range map. For example, by executing the object analysis process as to what each cluster that is an aggregate of bright spots and is detected from each map is, such as, for example, a car, a person, a wall, or a pole, a final output (detection object analysis information) 53 is outputted.

However, a problem in the configuration of the signal processing device (millimeter wave radar device) 100 illustrated in FIG. 4 is a processing cost of the azimuth angle estimation process in the azimuth angle estimation unit 107.

As described above, the azimuth angle estimation unit 107 is inputted with the plurality of (n pieces of) speed-range maps 51-1 to n generated by the plurality of (n pieces of) FFTs 106-1 to n, analyzes the plurality of (n pieces of) speed-range maps 51-1 to n, and generates one azimuth (azimuth angle) range map 52 through the azimuth angle estimation process.

The process of calculating a direction (azimuth angle) of an object has a large processing cost, and there is a problem that a processing delay is likely to occur.

In a robot or an automated vehicle that travels at a high speed, such a processing delay is critical and may cause an accident such as collision with an obstacle.

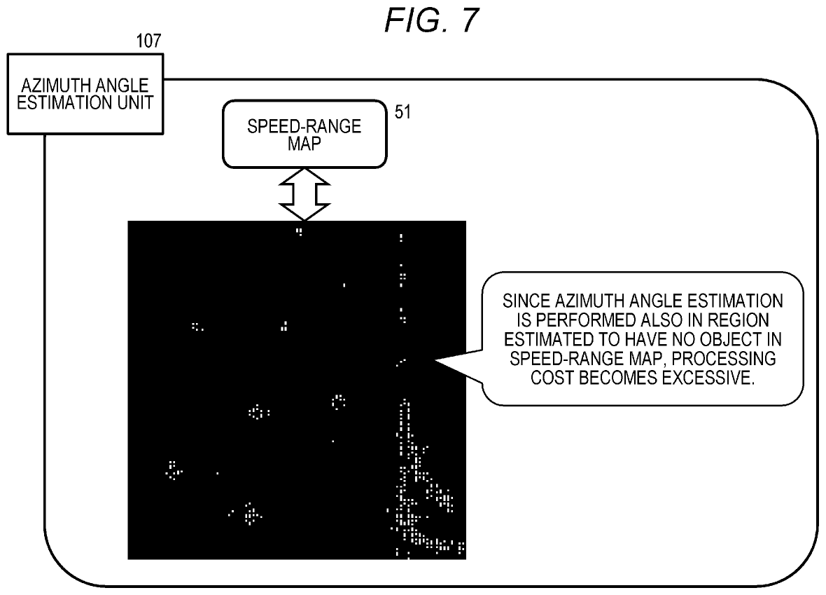

With reference to FIG. 7, a processing example of the azimuth angle estimation process using the plurality of (n pieces of) speed-range maps 51-1 to n and executed by the azimuth angle estimation unit 107 will be described.

FIG. 7 illustrates one speed-range map 51.

The azimuth angle estimation unit 107 also estimates an azimuth angle of a bright spot in a region having a low bright spot density where it is estimated that there is no object in this speed-range map 51. Therefore, the processing cost increases, that is, a processing time increases, and resources of a processor, a memory, and the like required for processing also increase.

As a result, a problem occurs such as a processing delay or resources of a processor, a memory, and the like being disabled for other data processing.

The signal processing device of the present disclosure is to solve this problem.

### 3. (First Embodiment) about Configuration and Processing of Signal Processing Device of Present Disclosure

Next, a configuration and processing of a signal processing device according to a first embodiment of the present disclosure will be described.

The signal processing device of the present disclosure has a configuration that solves the above-described problem, that is, the problem that the processing cost of the azimuth angle estimation process is excessive, and enables an efficient azimuth angle estimation process.

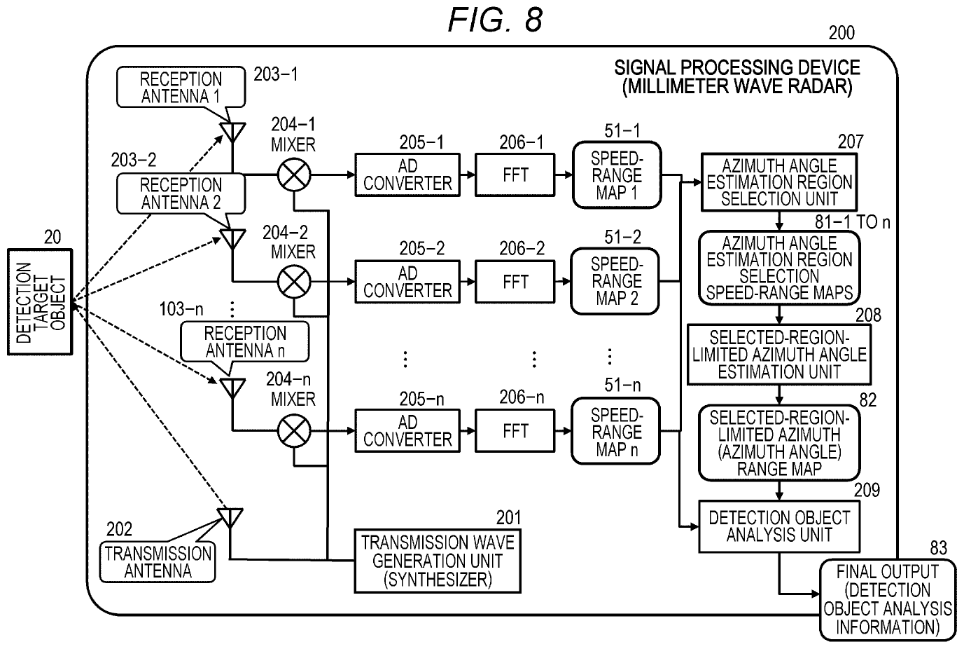

FIG. 8 is a diagram illustrating a configuration example of a signal processing device (millimeter wave radar device) 200 according to the first embodiment of the present disclosure.

The signal processing device (millimeter wave radar device) 200 of the present disclosure illustrated in FIG. 8 includes a transmission wave generation unit (synthesizer) 201, a transmission antenna 202, a plurality of (n pieces of) reception antennas 203-1 to n, a plurality of (n pieces of) mixers 204-1 to n for the individual reception antennas, AD converters 205-1 to n, and FFTs 206-1 to n, and additionally, an azimuth angle estimation region selection unit 207, a selected-region-limited azimuth angle estimation unit 208, and a detection object analysis unit 209.

Configurations and processing of the transmission wave generation unit (synthesizer) 201 to the FFTs 206-1 to n are similar to the configurations and processing of the transmission wave generation units (synthesizers) 201 to the FFTs 206-1 to n of the signal processing device (millimeter wave radar device) 100 described above with reference to FIG. 4.

The azimuth angle estimation region selection unit 207 and the selected-region-limited azimuth angle estimation unit 208 are configurations unique to the signal processing device (millimeter wave radar device) 200 of the present disclosure.

The detection object analysis unit 209 performs substantially similar processing to that of the detection object analysis unit 108 of the signal processing device (millimeter wave radar device) 100 described with reference to FIG. 4.

A configuration and processing of the signal processing device (millimeter wave radar device) 200 illustrated in FIG. 8 will be described.

The transmission wave generation unit (synthesizer) 201 generates a millimeter wave radar signal to be transmitted via the transmission antenna 202.

The millimeter wave radar signal generated by the transmission wave generation unit (synthesizer) 201 is transmitted via the transmission antenna 202.

The millimeter wave radar signal transmitted via the transmission antenna 202 is reflected by various objects and received by the plurality of (n pieces of) reception antennas 203-1 to n.

Note that, the figure illustrates an example of a reflected wave of only one detection target object 20, but in practice, reflected waves from a large number of various objects are received by the plurality of (n pieces of) reception antennas 203-1 to n.

The plurality of (n pieces of) reception antennas 203-1 to n is set at different positions as described above with reference to FIG. 1. Therefore, even if the reflection position of the detection target object 20 is the same, reception signals of the plurality of (n pieces of) reception antennas 203-1 to n are signals having different phases.

The reception signals of the plurality of (n pieces of) reception antennas 203-1 to n are respectively inputted to the mixers 204-1 to n in a subsequent stage.

The mixers 204-1 to n calculate difference signals between the reception signals of the individual reception antennas 203-1 to n and a transmission signal generated by the transmission wave generation unit (synthesizer) 201.

The difference signals generated by the mixers 204-1 to n are inputted to the AD converters 205-1 to n, to be converted into digital signals. The digital signal indicates a difference between the reception signal of each of the reception antennas 203-1 to n and the transmission signal generated by the transmission wave generation unit (synthesizer) 201.

The digital signals generated by the AD converters 205-1 to n are respectively inputted to the FFTs 206-1 to n in a subsequent stage.

The FFTs 206-1 to n each perform fast Fourier transform on the digital signals generated by the AD converters 205-1 to n, and perform a signal conversion process of converting a time domain signal into a frequency domain signal.

The FFTs 206-1 to n each execute the fast Fourier transform (FFT) process on the digital signals generated by the AD converters 205-1 to n, and output the speed-range maps 51-1 to n as illustrated in the figure.

The speed-range map 51 outputted by the FFT 206 is the map described above with reference to FIG. 5, and is a map having:

a speed (a relative speed with the signal processing device (radar)) of an object on a horizontal axis; and

a distance (a distance from the signal processing device (radar)) to the object on a vertical axis, and

values of these are set as orthogonal axes as illustrated in FIG. 5.

Note that the object is an object having reflected a radar wave.

A bright spot (white point) on the map illustrated in FIG. 5 is to be a point indicating a speed (Km/h) and a distance (m) of the detection object.

Note that, as described above with reference to FIG. 5, each one of bright spots in the speed-range map is (a speed and a distance) based on one reflection unit of an object calculated on the basis of a transmission/reception signal of the radar, and an aggregate (cluster) of a plurality of bright spots is set in a case where the object is a car, for example.

As described with reference to FIG. 5, for example, the cluster x illustrated in the figure is a cluster having such distance and speed characteristics of:

object distance=65 m, and

object speed=+15 km/h, and

it is possible to estimate that, from such cluster characteristics, the cluster x is a front vehicle traveling at a speed lower by 15 km than that of the own vehicle equipped with the signal processing device 100.

Furthermore, the cluster y is a cluster having such distance and speed characteristics of:

object distance=0 to 65 m, and

object speed=+45 km/h, and

it is possible to estimate that the cluster y is a side wall of a traveling path of the own vehicle (traveling at 45 km/h) equipped with the signal processing device 100.

As described above, from the speed-range map, only the distance and the speed (relative speed) of the detection object can be acquired, and a direction (azimuth angle) of the detection object cannot be acquired.

As illustrated in FIG. 8, the signal processing device (millimeter wave radar device) 200 of the present disclosure inputs the speed-range maps 51-1 to n generated by the FFTs 206-1 to n each, to the azimuth angle estimation region selection unit 207.

The azimuth angle estimation region selection unit 207 performs a process of selecting a region (pixel region) that should be subjected to the azimuth angle estimation process, for each of the speed-range maps 51-1 to n outputted from each of the FFTs 206-1 to n.

In the signal processing device (millimeter wave radar device) 100 described above with reference to FIG. 4, the speed-range maps 51-1 to n generated by the FFTs 106-1 to n each have been inputted to the azimuth angle estimation unit 107, and the azimuth angle estimation unit 107 has also performed azimuth angle estimation for all bright spots in the speed-range map, that is, bright spots in a region estimated to have no object. Therefore, there has been a problem that the processing cost increases and a processing delay or the like occurs.

The azimuth angle estimation region selection unit 207 of the present disclosure illustrated in FIG. 8 performs a process of selecting a region (pixel region) that should be subjected to the azimuth angle estimation process, for each of the speed-range maps 51-1 to n generated by each of the FFTs 206-1 to n, generates “azimuth angle estimation region selection speed-range maps 81-1 to n” indicating selected regions (pixel regions) that should be subjected to the azimuth angle estimation process, and inputs to the selected-region-limited azimuth angle estimation unit 208 of the next stage.

By using the “azimuth angle estimation region selection speed-range maps 81-1 to n”, the selected-region-limited azimuth angle estimation unit 208 executes the azimuth angle estimation process on only the region (pixel region) selected by the azimuth angle estimation region selection unit 207.

That is, rather than executing the azimuth angle estimation process on all the bright spots distributed in each of the speed-range maps 51-1 to n generated by each of the FFTs 206-1 to n, the selected-region-limited azimuth angle estimation unit 208 only needs to execute the azimuth angle estimation process on bright spots in the region (pixel region) selected by the azimuth angle estimation region selection unit 207. Therefore, the azimuth angle estimation process can be efficiently executed in a short time.

Note that, for each of the speed-range maps 51-1 to n generated by each of the FFTs 206-1 to n, the azimuth angle estimation region selection unit 207 selects a cluster region of an object estimated as an obstacle such as, for example, a car, a wall, or a person in a traveling direction of the own vehicle, generates the “azimuth angle estimation region selection speed-range maps 81-1 to n” indicating these selected cluster regions as selected regions (pixel regions) that should be subjected to the azimuth angle estimation process, and inputs to the selected-region-limited azimuth angle estimation unit 208 of the next stage.

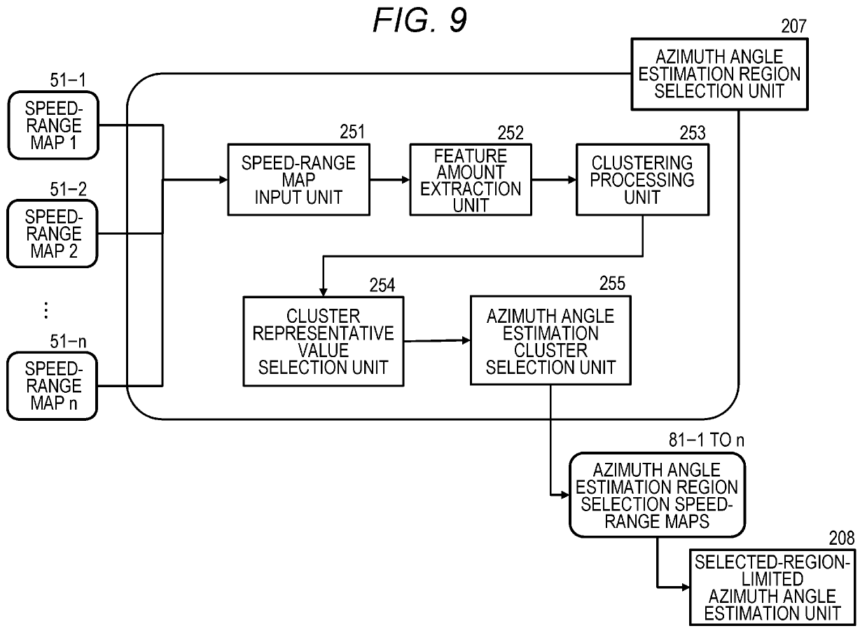

With reference to FIG. 9, a detailed configuration and processing of the azimuth angle estimation region selection unit 207 will be described.

As illustrated in FIG. 9, the azimuth angle estimation region selection unit 207 includes a speed-range map input unit 251, a feature amount extraction unit 252, a clustering processing unit 253, a cluster representative value selection unit 254, and an azimuth angle estimation cluster selection unit 255.

The speed-range map input unit 251 is inputted with each of the speed-range maps 51-1 to n generated by each of the FFTs 206-1 to n, and transfers to the feature amount extraction unit 252.

The feature amount extraction unit 252 extracts a feature amount from each of the speed-range maps 51-1 to n generated by each of the FFTs 206-1 to n.

The speed-range map is the map described above with reference to FIG. 5, and is a map having:

a speed (a relative speed with the signal processing device (radar)) of an object on a horizontal axis; and

a distance (a distance from the signal processing device (radar)) to the object on a vertical axis, and

values of these are set as orthogonal axes.

Note that the object is an object having reflected a radar wave.

A bright spot (white point) on the map illustrated in FIG. 5 is to be a point indicating a speed (Km/h) and a distance (m) of the detection object.

From this speed-range map, the feature amount extraction unit 252 extracts a feature amount effective for selecting a region (pixel region) that should be subjected to azimuth angle estimation. Specifically, for example, a feature amount useful for extraction of an obstacle object such as a vehicle, a person, or a building such as a wall or a pillar in front of the own vehicle is extracted. For example, a feature amount or the like of a bright spot distribution indicating whether or not a prescribed number defined in advance or more of bright spots are accumulated at a prescribed density defined in advance or more is extracted.

A bright spot set (cluster) in which a prescribed number or more of bright spots are accumulated at a prescribed density or more is a region having a high possibility of being an obstacle object such as a person or a building such as a wall or a pillar, and the feature amount extraction unit 252 extracts, for example, a feature amount that enables to distinguish such a region.

Note that, as a feature amount extraction algorithm in the feature amount extraction unit 252, it is preferable to use an algorithm in consideration of periodicity, satisfaction of an axiom of distance, an appropriate number of dimensions, a property of a clustering algorithm, and the like.

The feature amount extraction unit 252 extracts a feature amount from each of the speed-range maps 51-1 to n generated by each of the FFTs 206-1 to n, and outputs each of the speed-range maps 51-1 to n and the feature amount extracted from each map to the clustering processing unit 253.

The clustering processing unit 253 applies each of the speed-range maps 51-1 to n and the feature amount extracted from each map, which are inputted from the feature amount extraction unit 252, and performs clustering on bright spots of each of the speed-range maps 51-1 to n.

Specifically, a clustering process is executed in which, for example, a region having a feature amount of a bright spot distribution of a prescribed number or more and a prescribed density or more is set as a cluster having a feature amount corresponding to an obstacle object such as a person or a building such as a wall or a pillar.

Note that, as the clustering algorithm, for example, an algorithm such as density-based spatial clustering of applications with noise (DBSCAN) can be applied.

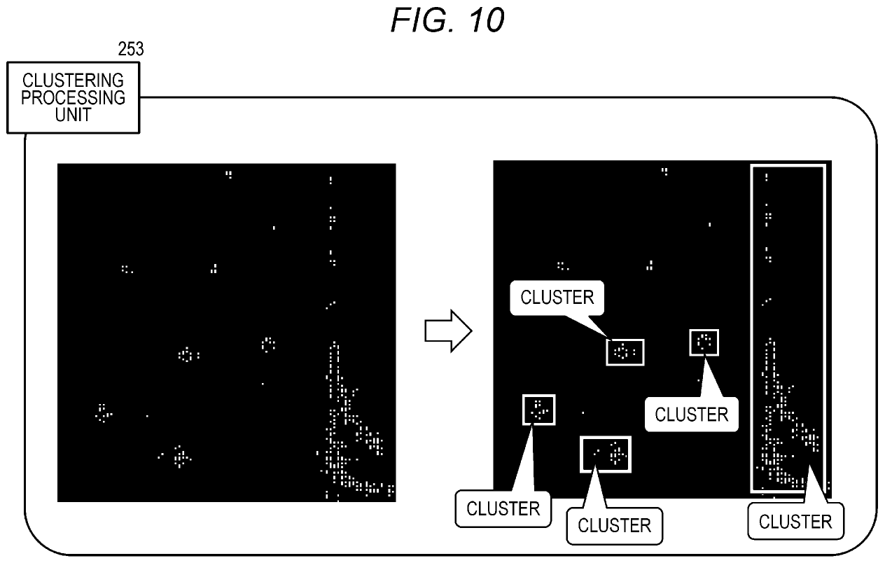

FIG. 10 is a view illustrating a specific example of a clustering process in the clustering processing unit 253.

As illustrated in FIG. 10, a region having a feature amount of a bright spot distribution of a prescribed number or more and a prescribed density or more is set as a cluster.

Next, the speed-range maps 51-1 to n in which the clusters are set are inputted to the cluster representative value selection unit 254.

The cluster representative value selection unit 254 acquires a representative value in the cluster that is set by the clustering processing unit 253.

As described above, the speed-range map is a map in which each of values (a speed and a distance) of:

a speed (a relative speed with the signal processing device (radar)) of an object on a horizontal axis; and

a distance (a distance from the signal processing device (radar)) to the object on a vertical axis

can be acquired.

Note that the object is an object having reflected a radar wave.

The cluster representative value selection unit 254 acquires a representative value of a size and (a speed and a distance) of the cluster that is set by the clustering processing unit 253. This representative value is used to determine what type of object the cluster corresponds to.

For example, the speed obtained as the representative value of the cluster varies depending on the object type corresponding to the cluster, such as a case of a building such as a wall, a case of a person, and a case of a vehicle, and object identification can be performed on the basis of the cluster representative value.

Note that, in the present embodiment, the object identification corresponding to each cluster is executed by the detection object analysis unit 209.

The detection object analysis unit 209 can perform object identification with high accuracy by using the cluster representative value or the like.

The speed-range map with setting of the cluster including, as attribute data, the cluster representative value that is set by the cluster representative value selection unit 254 is inputted to the azimuth angle estimation cluster selection unit 255.

The azimuth angle estimation cluster selection unit 255 performs a process of selecting an azimuth angle estimation target region, specifically, an azimuth angle estimation target cluster, from the speed-range map in which the cluster including the cluster representative value as attribute data is set.

For example, the azimuth angle estimation cluster selection unit 255 may select all of the clusters that are set by the clustering processing unit 253 on the basis of a feature amount, as the azimuth angle estimation target region (cluster).

Alternatively, on the basis of the cluster representative value that is set by the cluster representative value selection unit 254, only a cluster having a representative value satisfying a predetermined condition may be selected as the azimuth angle estimation target region (cluster), from the clusters that are set by the clustering processing unit 253.

As described above, the azimuth angle estimation cluster selection unit 255 selects, as the azimuth angle estimation target region (cluster), all or some of clusters that are set by the clustering processing unit 253 on the basis of a feature amount, generates a speed-range map indicating the azimuth angle estimation target region (cluster), that is, the “azimuth angle estimation region selection speed-range maps 81-1 to n”, and inputs the generated map to the next selected-region-limited azimuth angle estimation unit 208.

As described above, the azimuth angle estimation region selection unit 207 generates the “azimuth angle estimation region selection speed-range maps 81-1 to n” including selection information of the cluster to be an azimuth angle estimation target, and inputs the generated map to the next selected-region-limited azimuth angle estimation unit 208.

The selected-region-limited azimuth angle estimation unit 208 is inputted with the “azimuth angle estimation region selection speed-range maps 81-1 to n” from the azimuth angle estimation region selection unit 207, refers to azimuth angle estimation target cluster selection information of the “azimuth angle estimation region selection speed-range maps 81-1 to n”, and executes the azimuth angle estimation process for only the selected cluster region.

That is, the azimuth angle estimation is not performed for all the bright spots distributed in the speed-range map, but the azimuth angle estimation process is executed only for bright spots in a pixel region belonging to a cluster selected as the azimuth angle estimation target region by the azimuth angle estimation region selection unit 207.

By performing azimuth angle estimation of only a limited region as described above, it is possible to efficiently perform azimuth angle estimation in a short time.

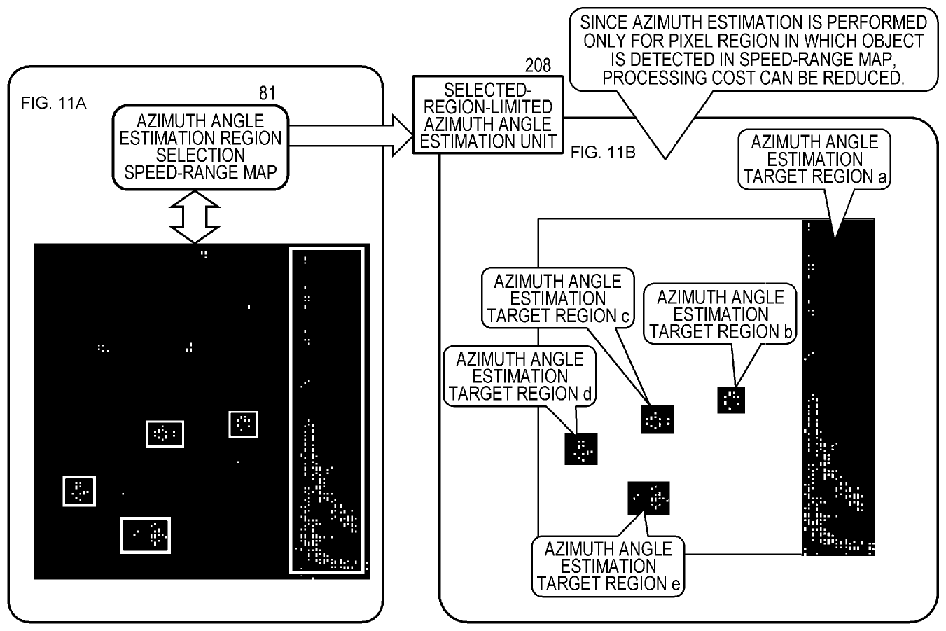

FIG. 11 is a view illustrating a specific example of the azimuth angle estimation process executed by the selected-region-limited azimuth angle estimation unit 208.

FIG. 11(1) is a view illustrating an example of an azimuth angle estimation region selection speed-range map 81 generated by the azimuth angle estimation region selection unit 207.

In the azimuth angle estimation region selection speed-range map 81, an azimuth angle estimation target cluster (a rectangular region) is clearly indicated.

FIG. 11(2) is a view for explaining a cluster region to be subjected to azimuth angle estimation in the azimuth angle estimation process executed by the selected-region-limited azimuth angle estimation unit 208.

The selected-region-limited azimuth angle estimation unit 208 selects only bright spots belonging to azimuth angle estimation target regions a to e (clusters a to e) illustrated in FIG. 11(2), and performs the azimuth angle estimation process.

The azimuth angle estimation process for only the limited region as described above enables efficient and short-time processing.

As described above, the selected-region-limited azimuth angle estimation unit 208 executes the azimuth angle estimation process for only the limited cluster region, generates a selected-region-limited azimuth (azimuth angle) range map 82, and outputs the generated map to the detection object analysis unit 209.

Similarly to the azimuth (azimuth angle) range map described above with reference to FIG. 6, the selected-region-limited azimuth (azimuth angle) range map 82 generated by the selected-region-limited azimuth angle estimation unit 208 is a map having:

an azimuth angle (an angle (bearing) indicating an object direction) of an object on a horizontal axis; and

a distance (a distance from the signal processing device (radar)) to the object on a vertical axis, and

values of these are set as orthogonal axes.

Note that the object is an object having reflected a radar wave.

A bright spot (white point) on the map illustrated in FIG. 6 is to be a point indicating an azimuth angle (°) and the distance (m) of a detection object.

However, the selected-region-limited azimuth angle estimation unit 208 executes the azimuth angle estimation process for only a limited cluster region of the speed-range map, and generates an azimuth (azimuth angle) range map by calculating an estimated azimuth angle of the limited cluster region. Therefore, the selected-region-limited azimuth (azimuth angle) range map 82 generated by the selected-region-limited azimuth angle estimation unit 208 does not include azimuth angle estimation information other than the limited cluster region.

The detection object analysis unit 209 is inputted with the selected-region-limited azimuth (azimuth angle) range map 82 generated by the selected-region-limited azimuth angle estimation unit 208, and the speed-range maps 51-1 to n generated by the FFTs 206-1 to n each, and the detection object analysis unit 209 executes an object analysis process using these maps. For example, by executing the object analysis process as to what each cluster that is an aggregate of bright spots and is detected from each map is, such as, for example, a car, a person, a wall, or a pole, a final output (detection object analysis information) 83 is outputted.

As described above, in the signal processing device (millimeter wave radar device) 200 illustrated in FIG. 8, the azimuth angle estimation region selection unit 207 selects a region (cluster) to be an azimuth angle estimation target, for example, a cluster region including an object that can be an obstacle, and generates the azimuth angle estimation region selection speed-range map 81 in which the selected cluster is designated.

The selected-region-limited azimuth angle estimation unit 208 is inputted with the azimuth angle estimation region selection speed-range map 81 in which the selected cluster is designated by the azimuth angle estimation region selection unit 207, and performs azimuth angle estimation for only the selected cluster as a processing target. As a result, it is possible to efficiently estimate the azimuth angle.

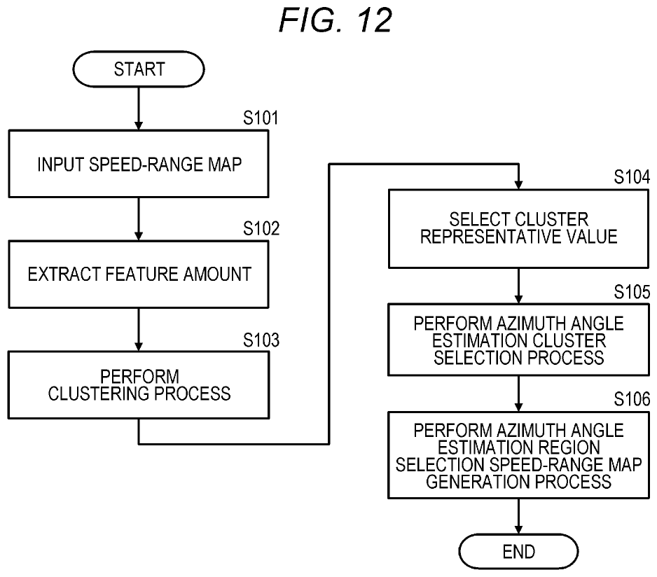

Next, with reference to a flowchart illustrated in FIG. 12, a description is given to processing executed by the azimuth angle estimation region selection unit 207 of the signal processing device (millimeter wave radar device) 200 illustrated in FIG. 8, that is, a generation sequence of the “azimuth angle estimation region selection speed-range map 81”.

Note that the processing according to the flowchart described below can be executed under control of a control unit (data processing unit) including a CPU or the like having a program execution function of the signal processing device, in accordance with a program stored in a memory in the signal processing device.

Hereinafter, processing of each step of the flow illustrated in FIG. 12 will be sequentially described.

(Step S101)

The azimuth angle estimation region selection unit 207 of the signal processing device (millimeter wave radar device) 200 illustrated in FIG. 8 is first inputted with a speed-range map in step S101.

This process is a process executed by the speed-range map input unit 251 of the azimuth angle estimation region selection unit 207 illustrated in FIG. 9.

The speed-range map input unit 251 is inputted with each of the speed-range maps 51-1 to n generated by each of the FFTs 206-1 to n of the signal processing device 200 illustrated in FIG. 8.

(Step S102)

Next, in step S102, the azimuth angle estimation region selection unit 207 executes a feature amount extraction process from each of the speed-range maps 51-1 to n.

This process is a process executed by the feature amount extraction unit 252 of the azimuth angle estimation region selection unit 207 illustrated in FIG. 9.

From the speed-range map, the feature amount extraction unit 252 extracts a feature amount effective for selecting a region (pixel region) that should be subjected to azimuth angle estimation. Specifically, for example, a feature amount useful for extraction of an obstacle object such as a vehicle, a person, or a building such as a wall or a pillar in front of the own vehicle is extracted. For example, a feature amount or the like of a bright spot distribution indicating whether or not a prescribed number or more of bright spots are accumulated at a prescribed density or more is extracted.

(Step S103)

Next, in step S103, the azimuth angle estimation region selection unit 207 executes a clustering process.

This process is a process executed by the clustering processing unit 253 of the azimuth angle estimation region selection unit 207 illustrated in FIG. 9.

The clustering processing unit 253 applies each of the speed-range maps 51-1 to n and the feature amount extracted from each map, which are inputted from the feature amount extraction unit 252, and performs clustering on bright spots of each of the speed-range maps 51-1 to n.

Specifically, a clustering process is executed in which, for example, a region having a feature amount of a bright spot distribution of a prescribed number or more and a prescribed density or more is set as a cluster having a feature amount corresponding to an obstacle object such as a person or a building such as a wall or a pillar.

(Step S104)

Next, in step S104, the azimuth angle estimation region selection unit 207 executes a cluster representative value selection process.

This process is a process executed by the cluster representative value selection unit 254 of the azimuth angle estimation region selection unit 207 illustrated in FIG. 9.

The cluster representative value selection unit 254 acquires a representative value in the cluster that is set by the clustering processing unit 253.

The cluster representative value selection unit 254 acquires a representative value of a size, (a speed and a distance), or the like of the cluster that is set by the clustering processing unit 253. This representative value is used to determine what type of object the cluster corresponds to.

(Steps S105 to S106)

Next, the azimuth angle estimation region selection unit 207 executes an azimuth angle estimation cluster selection process in step S105, and generates an azimuth angle estimation region selection speed-range map in step S106.

These processes are processes executed by the azimuth angle estimation cluster selection unit 255 of the azimuth angle estimation region selection unit 207 illustrated in FIG. 9.

The azimuth angle estimation cluster selection unit 255 selects, as the azimuth angle estimation target region (cluster), all or some of clusters that are set by the clustering processing unit 253 on the basis of a feature amount, and generates a speed-range map indicating the azimuth angle estimation target region (cluster), that is, the “azimuth angle estimation region selection speed-range maps 81-1 to n”.

The generated map is inputted to the next selected-region-limited azimuth angle estimation unit 208.

The selected-region-limited azimuth angle estimation unit 208 is inputted with the “azimuth angle estimation region selection speed-range maps 81-1 to n”, refers to azimuth angle estimation target cluster selection information of the “azimuth angle estimation region selection speed-range maps 81-1 to n”, and executes the azimuth angle estimation process for only the selected cluster region.

In this way, by performing the azimuth angle estimation process using only the limited region as the azimuth angle estimation target region, it is possible to perform efficient azimuth angle estimation in a short time.

### 4. (Second Embodiment) about Configuration and Processing of Signal Processing Device that Executes Azimuth Angle Estimation for Only Object of Specific Type

Next, as a second embodiment of the present disclosure, an embodiment of a signal processing device that executes azimuth angle estimation of only an object of a specific type will be described.

The second embodiment is an embodiment in which only an object of a specific type is selected from objects of specific types, for example, objects to be obstacles such as only vehicles or only pedestrians, and azimuth angle estimation is performed only for a constituent region of a cluster corresponding to the selected object.

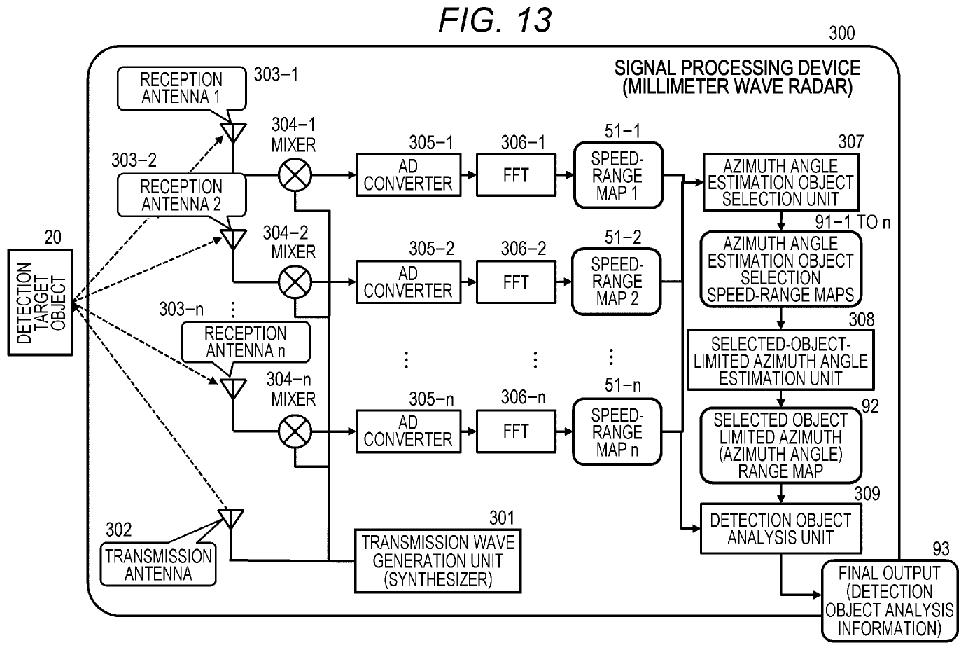

FIG. 13 is a diagram illustrating a configuration example of a signal processing device (millimeter wave radar device) 300 according to the second embodiment of the present disclosure.

The signal processing device (millimeter wave radar device) 300 of the present disclosure illustrated in FIG. 13 includes a transmission wave generation unit (synthesizer) 301, a transmission antenna 302, a plurality of (n pieces of) reception antennas 303-1 to n, a plurality of (n pieces of) mixers 304-1 to n for the individual reception antennas, AD converters 305-1 to n, and FFTs 306-1 to n, and additionally, an azimuth angle estimation object selection unit 307, a selected-object-limited azimuth angle estimation unit 308, and a detection object analysis unit 309.

Configurations and processing of the transmission wave generation unit (synthesizer) 301 to the FFT 306-1 to n are similar to the configurations and processing of the transmission wave generation units (synthesizers) 301 to the FFT 306-1 to n of the signal processing device (millimeter wave radar device) 100 described above with reference to FIG. 4.

The azimuth angle estimation object selection unit 307 and the selected-object-limited azimuth angle estimation unit 308 are configurations unique to the signal processing device (millimeter wave radar device) 300 of the second embodiment.

The detection object analysis unit 309 performs substantially similar processing to that of the detection object analysis unit 108 of the signal processing device (millimeter wave radar device) 100 described with reference to FIG. 4.

A configuration and processing of the signal processing device (millimeter wave radar device) 300 illustrated in FIG. 13 will be described.

The transmission wave generation unit (synthesizer) 301 generates a millimeter wave radar signal to be transmitted via the transmission antenna 302.

The millimeter wave radar signal generated by the transmission wave generation unit (synthesizer) 301 is transmitted via the transmission antenna 302.

The millimeter wave radar signal transmitted via the transmission antenna 302 is reflected by various objects and received by the plurality of (n pieces of) reception antennas 303-1 to n.

Note that, the figure illustrates an example of a reflected wave of only one detection target object 30, but in practice, reflected waves from a large number of various objects are received by the plurality of (n pieces of) reception antennas 303-1 to n.

The plurality of (n pieces of) reception antennas 303-1 to n is set at different positions as described above with reference to FIG. 1. Therefore, even if the reflection position of the detection target object 30 is the same, reception signals of the plurality of (n pieces of) reception antennas 303-1 to n are signals having different phases.

The reception signals of the plurality of (n pieces of) reception antennas 303-1 to n are respectively inputted to the mixers 304-1 to n in a subsequent stage.

The mixers 304-1 to n calculate difference signals between the reception signals of the individual reception antennas 303-1 to n and a transmission signal generated by the transmission wave generation unit (synthesizer) 301.

The difference signals generated by the mixers 304-1 to n are inputted to the AD converters 305-1 to n, to be converted into digital signals. The digital signal indicates a difference between the reception signal of each of the reception antennas 303-1 to n and the transmission signal generated by the transmission wave generation unit (synthesizer) 301.

The digital signals generated by the AD converters 305-1 to n are respectively inputted to the FFTs 306-1 to n in a subsequent stage.

The FFTs 306-1 to n each perform fast Fourier transform on the digital signals generated by the AD converters 305-1 to n, and perform a signal conversion process of converting a time domain signal into a frequency domain signal.

The FFTs 306-1 to n each execute the fast Fourier transform (FFT) process on the digital signals generated by the AD converters 305-1 to n, and output the speed-range maps 51-1 to n as illustrated in the figure.

The speed-range map 51 outputted by the FFT 306 is the map described above with reference to FIG. 5, and is a map having:

a speed (a relative speed with the signal processing device (radar)) of an object on a horizontal axis; and

a distance (a distance from the signal processing device (radar)) to the object on a vertical axis, and

values of these are set as orthogonal axes as illustrated in FIG. 5.

Note that the object is an object having reflected a radar wave.

A bright spot (white point) on the map illustrated in FIG. 5 is to be a point indicating a speed (Km/h) and a distance (m) of the detection object.

Note that, as described above with reference to FIG. 5, each one of bright spots in the speed-range map is (a speed and a distance) based on one reflection unit of an object calculated on the basis of a transmission/reception signal of the radar, and an aggregate (cluster) of a plurality of bright spots is set in a case where the object is a car, for example.

As described with reference to FIG. 5, for example, the cluster x illustrated in the figure is a cluster having such distance and speed characteristics of:

object distance=65 m, and

object speed=+15 km/h, and

it is possible to estimate that, from such cluster characteristics, the cluster x is a front vehicle traveling at a speed lower by 15 km than that of the own vehicle equipped with the signal processing device 100.

Furthermore, the cluster y is a cluster having such distance and speed characteristics of:

object distance=0 to 65 m, and

object speed=+45 km/h, and

it is possible to estimate that the cluster y is a side wall of a traveling path of the own vehicle (traveling at 45 km/h) equipped with the signal processing device 100.

As described above, from the speed-range map, only the distance and the speed (relative speed) of the detection object can be acquired, and a direction (azimuth angle) of the detection object cannot be acquired.

As illustrated in FIG. 13, the signal processing device (millimeter wave radar device) 300 of the present disclosure inputs the speed-range maps 51-1 to n generated by the FFTs 306-1 to n each, to the azimuth angle estimation object selection unit 307.

For each of the speed-range maps 51-1 to n generated by each of the FFTs 306-1 to n, the azimuth angle estimation object selection unit 307 performs a process of selecting an object region of a specific type, for example, an object region of a specific type such as “vehicle” or “person” as a region (pixel region) that should be subjected to the azimuth angle estimation process.

Note that the object type to be selected is determined in advance.

As described above, for each of the speed-range maps 51-1 to n generated by each of the FFTs 306-1 to n, the azimuth angle estimation object selection unit 307 of the present disclosure illustrated in FIG. 13 performs, for example, a process of selecting a region (pixel region) of “vehicle” as the azimuth angle estimation target region, and a process of selecting a region (pixel region) of “person” as the azimuth angle estimation target region.

The azimuth angle estimation object selection unit 307 further generates “azimuth angle estimation object selection speed-range maps 91-1 to n” indicating object regions (pixel regions) that should be subjected to the azimuth angle estimation process, and outputs to the selected-object-limited azimuth angle estimation unit 308 of the next stage.

The selected-object-limited azimuth angle estimation unit 308 uses the “azimuth angle estimation object selection speed-range maps 91-1 to n”, to execute the azimuth angle estimation process for only the object regions (pixel regions) of the specific type selected by the azimuth angle estimation object selection unit 307.

That is, rather than executing the azimuth angle estimation process on all the bright spots distributed in each of the speed-range maps 51-1 to n generated by the FFTs 306-1 to n, the selected-object-limited azimuth angle estimation unit 308 is only required to execute the azimuth angle estimation process for only a bright spot belonging an object region (pixel region) of a specific type selected by the azimuth angle estimation object selection unit 307. Therefore, the azimuth angle estimation process can be efficiently executed in a short time.

As described above, for each of the speed-range maps 51-1 to n generated by each of the FFTs 306-1 to n, the azimuth angle estimation object selection unit 307 selects a cluster region corresponding to one type or a plurality of types of object types for objects estimated as obstacles such as, for example, a car, a wall, or a person in a traveling direction of the own vehicle, generates the “azimuth angle estimation object selection speed-range maps 91-1 to n” indicating these selected cluster regions as selected regions (pixel regions) that should be subjected to the azimuth angle estimation process, and outputs to the selected-object-limited azimuth angle estimation unit 308 of the next stage.

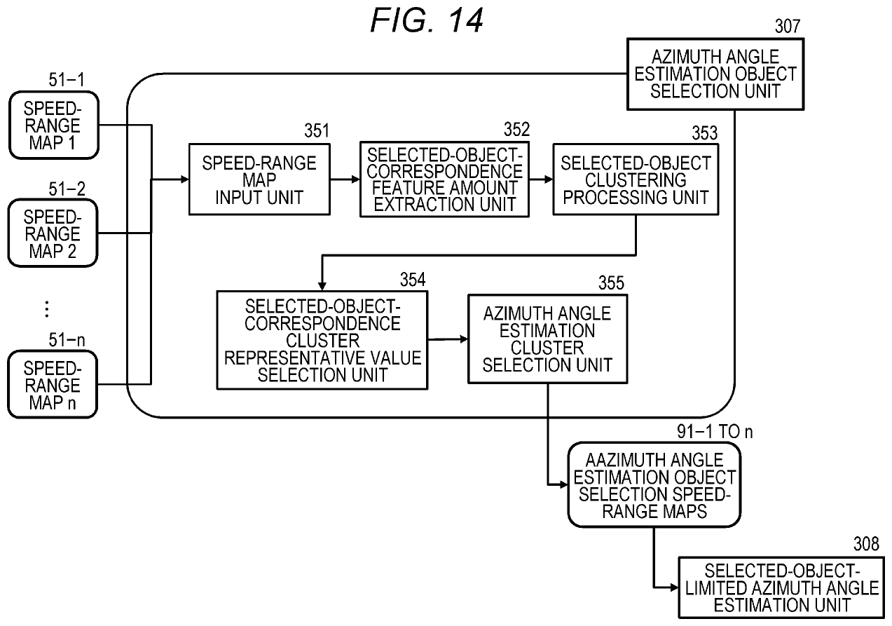

With reference to FIG. 14, a detailed configuration and processing of the azimuth angle estimation object selection unit 307 will be described.

As illustrated in FIG. 14, the azimuth angle estimation object selection unit 307 includes a speed-range map input unit 351, a selected-object-correspondence feature amount extraction unit 352, a selected-object clustering processing unit 353, a selected-object-correspondence cluster representative value selection unit 354, and an azimuth angle estimation cluster selection unit 355.

The speed-range map input unit 351 is inputted with each of the speed-range maps 51-1 to n generated by each of the FFTs 306-1 to n, and transfers to the selected-object-correspondence feature amount extraction unit 352.

The selected-object-correspondence feature amount extraction unit 352 extracts a feature amount corresponding to the selected object from each of the speed-range maps 51-1 to n generated by each of the FFTs 306-1 to n.

The speed-range map is the map described above with reference to FIG. 5, and is a map having:

a speed (a relative speed with the signal processing device (radar)) of an object on a horizontal axis; and

a distance (a distance from the signal processing device (radar)) to the object on a vertical axis, and

values of these are set as orthogonal axes.

Note that the object is an object having reflected a radar wave.

A bright spot (white point) on the map illustrated in FIG. 5 is to be a point indicating a speed (Km/h) and a distance (m) of the detection object.

The selected-object-correspondence feature amount extraction unit 352 extracts, from this speed-range map, a feature amount effective for selecting a region (pixel region) of a specific object that should be subjected to azimuth angle estimation, for example, a vehicle.

Specifically, for example, in a case where the selected object is a vehicle in front of the own vehicle, a feature amount useful for extraction of the vehicle is extracted. For example, extraction is performed on feature amount or the like, of a bright spot, that is effective for determining whether or not a bright spot set has a prescribed number or more of bright spots accumulated at a prescribed density or higher, and speed or distance information of the bright spot set has a value estimated to be a vehicle. That is, a feature amount corresponding to the selected object type is extracted.

The selected-object-correspondence feature amount extraction unit 352 extracts a feature amount from each of the speed-range maps 51-1 to n generated by each of the FFTs 306-1 to n, and outputs each of the speed-range maps 51-1 to n and the feature amount extracted from each map to the clustering processing unit 353.

The selected-object clustering processing unit 353 applies each of the speed-range maps 51-1 to n and the feature amount extracted from each map, which are inputted from the selected-object-correspondence feature amount extraction unit 352, to perform clustering on bright spots of each of the speed-range maps 51-1 to n.

Specifically, a clustering process is executed in which a region having a feature amount effective for selecting a region (pixel region) of a specific object that should be subjected to azimuth angle estimation, for example, a vehicle, is set as an azimuth angle estimation cluster.

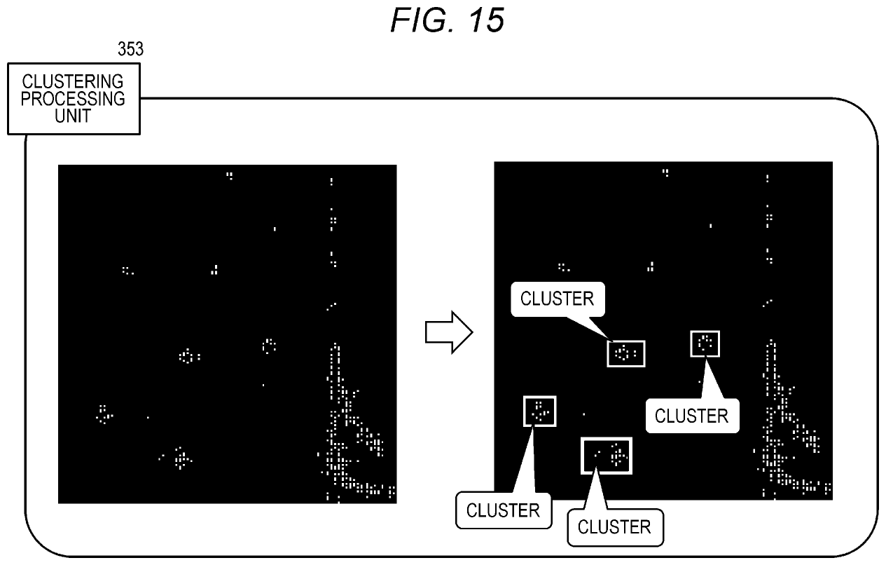

FIG. 15 is a view illustrating a specific example of the clustering process in the selected-object clustering processing unit 353.

The example illustrated in FIG. 15 is a clustering processing example with setting of a cluster having a feature amount effective for selecting a region (pixel region) of a specific object that should be subjected to azimuth angle estimation, for example, a vehicle.

Rectangular regions illustrated in a map illustrated on a right side of FIG. 15 are clusters of regions estimated as vehicles.

Next, the speed-range maps 51-1 to n in which the clusters are set are inputted to the selected-object-correspondence cluster representative value selection unit 354.

The selected-object-correspondence cluster representative value selection unit 354 acquires a representative value in the cluster that is set by the selected-object clustering processing unit 353.

As described above, the speed-range map is a map in which each of values (a speed and a distance) of:

a speed (a relative speed with the signal processing device (radar)) of an object on a horizontal axis; and

a distance (a distance from the signal processing device (radar)) to the object on a vertical axis

can be acquired.

Note that the object is an object having reflected a radar wave.

The selected-object-correspondence cluster representative value selection unit 354 acquires a representative value of a size, (a speed and a distance), or the like of the cluster that is set by the selected-object clustering processing unit 353. This representative value is used to determine whether or not the cluster can be determined as a cluster corresponding to the region of the selected cluster type, for example, the car.

The speed-range map with setting of the cluster including, as attribute data, the cluster representative value that is set by the selected-object-correspondence cluster representative value selection unit 354 is inputted to the azimuth angle estimation cluster selection unit 355.

The azimuth angle estimation cluster selection unit 355 performs a process of selecting an azimuth angle estimation target region, specifically, an azimuth angle estimation target cluster, from the speed-range map in which the cluster including the cluster representative value as attribute data is set.

For example, the azimuth angle estimation cluster selection unit 355 may select all of the clusters that are set by the selected-object clustering processing unit 353 on the basis of a feature amount, as the azimuth angle estimation target region (cluster).

Alternatively, on the basis of the cluster representative value that is set by the selected-object-correspondence cluster representative value selection unit 354, only a cluster having a representative value satisfying a predetermined condition may be selected as the azimuth angle estimation target region (cluster), from the clusters that are set by the selected-object clustering processing unit 353.

In this way, the azimuth angle estimation cluster selection unit 355 selects all or some of clusters that are set by the selected-object clustering processing unit 353 on the basis of a feature amount, generates a speed-range map indicating the azimuth angle estimation target region (cluster), that is, the “azimuth angle estimation object selection speed-range maps 91-1 to n”, and inputs the generated map to the next selected-object-limited azimuth angle estimation unit 308.

As described above, the azimuth angle estimation object selection unit 307 generates the “azimuth angle estimation object selection speed-range maps 91-1 to n” including selection information of the cluster to be the azimuth angle estimation target, and inputs the generated map to the next selected-object-limited azimuth angle estimation unit 308.

The selected-object-limited azimuth angle estimation unit 308 is inputted with the “azimuth angle estimation object selection speed-range maps 91-1 to n” from the azimuth angle estimation object selection unit 307, refers to azimuth angle estimation target cluster selection information of the “azimuth angle estimation object selection speed-range maps 91-1 to n”, and executes the azimuth angle estimation process for only the selected cluster region.

That is, the azimuth angle estimation is not performed for all the bright spots distributed in the speed-range map, but the azimuth angle estimation process is executed for only objects of the specific type selected as the azimuth angle estimation target region by the azimuth angle estimation object selection unit 307, for example, bright spots in a pixel region belonging to a cluster corresponding to a vehicle object.

By performing azimuth angle estimation of only a limited region as described above, it is possible to efficiently perform azimuth angle estimation in a short time.

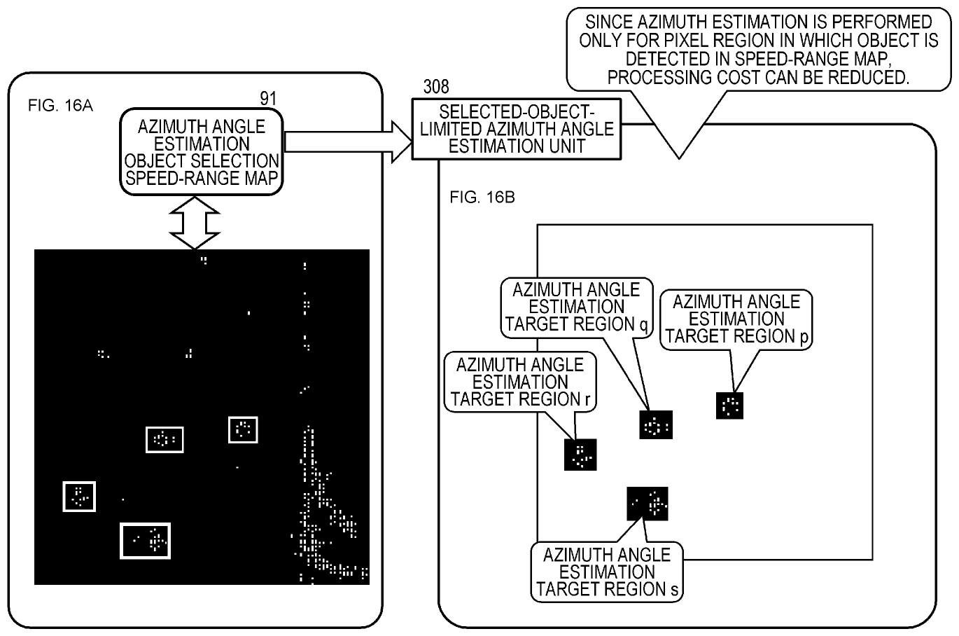

FIG. 16 is a view illustrating a specific example of the azimuth angle estimation process executed by the selected-object-limited azimuth angle estimation unit 308.

FIG. 16(1) is a view illustrating an example of an azimuth angle estimation object selection speed-range map 91 generated by the azimuth angle estimation object selection unit 307.

In the azimuth angle estimation object selection speed-range map 91, an azimuth angle estimation target cluster (a rectangular region) corresponding to an object of a specific type, for example, a vehicle object is clearly indicated.

FIG. 16(2) is a view for explaining a cluster region to be subjected to azimuth angle estimation in the azimuth angle estimation process executed by the selected-object-limited azimuth angle estimation unit 308.

The selected-object-limited azimuth angle estimation unit 308 selects only azimuth angle estimation target regions p to s illustrated in FIG. 16(2), and performs the azimuth angle estimation process.

The azimuth angle estimation target regions p to s illustrated in FIG. 16(2) are clusters corresponding to an object of a specific type, for example, a vehicle object.

As described above, the selected-object-limited azimuth angle estimation unit 308 performs the azimuth angle estimation process for only an object region of a specific alcoholic beverage, such as, for example, a cluster corresponding to a vehicle object. This configuration enables efficient and short-time processing.

As described above, the selected-object-limited azimuth angle estimation unit 308 executes the azimuth angle estimation process for only the limited cluster region corresponding to the specific object type, generates a selected-object-limited azimuth (azimuth angle) range map 92, and outputs the generated map to the detection object analysis unit 309.

Similarly to the azimuth (azimuth angle) range map described above with reference to FIG. 6, the selected-object-limited azimuth (azimuth angle) range map 92 generated by the selected-object-limited azimuth angle estimation unit 308 is a map having:

an azimuth angle (an angle (bearing) indicating an object direction) of an object on a horizontal axis; and

a distance (a distance from the signal processing device (radar)) to the object on a vertical axis, and

values of these are set as orthogonal axes

Note that the object is an object having reflected a radar wave.

A bright spot (white point) on the map illustrated in FIG. 6 is to be a point indicating an azimuth angle (°) and the distance (m) of a detection object.

However, the selected-object-limited azimuth angle estimation unit 308 executes the azimuth angle estimation process for only a limited cluster region of the speed-range map, and generates an azimuth (azimuth angle) range map by calculating an estimated azimuth of the limited cluster region. Therefore, the selected-object-limited azimuth (azimuth angle) range map 92 generated by the selected-object-limited azimuth angle estimation unit 308 does not include azimuth angle estimation information other than the limited cluster region such as a cluster corresponding to a vehicle object, for example.

The detection object analysis unit 309 is inputted with the selected-object-limited azimuth (azimuth angle) range map 92 generated by the selected-object-limited azimuth angle estimation unit 308 and the speed-range maps 51-1 to n generated by the FFT 306-1 to n each, and the detection object analysis unit 309 executes the object analysis process using these maps, and outputs a final output (detection object analysis information) 93.

As described above, in the signal processing device (millimeter wave radar device) 300 illustrated in FIG. 13, the azimuth angle estimation object selection unit 307 selects a region (cluster) to be an azimuth angle estimation target as a cluster corresponding to an object of a specific type such as, for example, a vehicle object, and generates the azimuth angle estimation object selection speed-range map 91 in which the selected cluster is designated.

The selected-object-limited azimuth angle estimation unit 308 is inputted with the azimuth angle estimation object selection speed-range map 91 in which the selected cluster is designated by the azimuth angle estimation object selection unit 307, and performs azimuth angle estimation for only the selected cluster as a processing target. As a result, it is possible to efficiently estimate the azimuth angle.

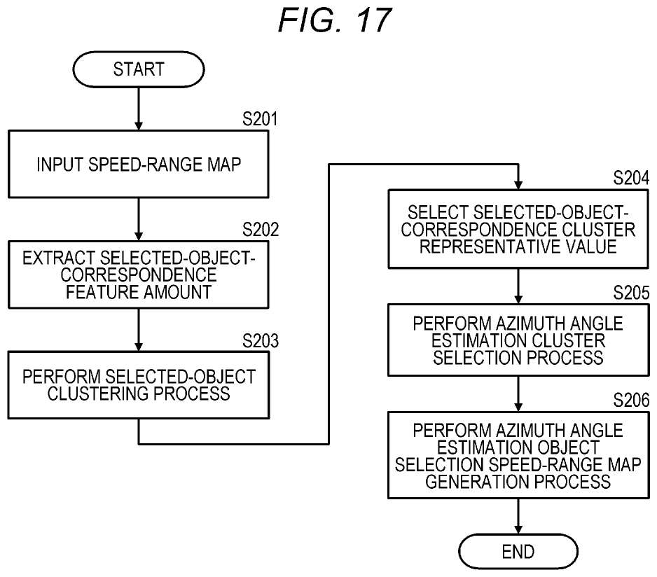

Next, with reference to a flowchart illustrated in FIG. 17, a description is given to processing executed by the azimuth angle estimation object selection unit 307 of the signal processing device (millimeter wave radar device) 300 illustrated in FIG. 13, that is, a generation sequence of the “azimuth angle estimation object selection speed-range map 91”.

Note that the processing according to the flowchart described below can be executed under control of a control unit (data processing unit) including a CPU or the like having a program execution function of the signal processing device, in accordance with a program stored in a memory in the signal processing device.

Hereinafter, processing of each step of the flow illustrated in FIG. 17 will be sequentially described.

(Step S201)

The azimuth angle estimation object selection unit 307 of the signal processing device (millimeter wave radar device) 300 illustrated in FIG. 13 is first inputted with a speed-range map in step S201.

This process is a process executed by the speed-range map input unit 351 of the azimuth angle estimation object selection unit 307 illustrated in FIG. 14.

The speed-range map input unit 351 is inputted with each of the speed-range maps 51-1 to n generated by each of the FFTs 306-1 to n of the signal processing device 300 illustrated in FIG. 13.

(Step S202)

Next, in step S202, the azimuth angle estimation object selection unit 307 executes a selected-object-correspondence feature amount extraction process from each of the speed-range maps 51-1 to n.

This process is a process executed by the selected-object-correspondence feature amount extraction unit 352 of the azimuth angle estimation object selection unit 307 illustrated in FIG. 14.

The selected-object-correspondence feature amount extraction unit 352 extracts, from the speed-range map, a feature amount effective for selecting a region (pixel region) of a specific object that should be subjected to azimuth angle estimation, for example, a vehicle.

Specifically, for example, in a case where the selected object is a vehicle in front of the own vehicle, a feature amount useful for extraction of the vehicle is extracted. For example, extraction is performed on feature amount or the like, of a bright spot, that is effective for determining whether or not a bright spot set has a prescribed number or more of bright spots accumulated at a prescribed density or higher, and speed or distance information of the bright spot set has a value estimated to be a vehicle.

(Step S203)

Next, in step S203, the azimuth angle estimation object selection unit 307 executes a selected-object clustering process.

This process is a process executed by the selected-object clustering processing unit 353 of the azimuth angle estimation object selection unit 307 illustrated in FIG. 14.

The selected-object clustering processing unit 353 applies each of the speed-range maps 51-1 to n and a selected-object-correspondence feature amount extracted from each map, which are inputted from the selected-object-correspondence feature amount extraction unit 352, to perform clustering on bright spots of each of the speed-range maps 51-1 to n.

Specifically, for example, a clustering process is executed in which a region having a feature amount effective for selecting a region (pixel region) of a specific object that should be subjected to azimuth angle estimation, for example, a vehicle, is set as an azimuth angle estimation cluster.

(Step S204)

Next, in step S204, the azimuth angle estimation object selection unit 307 executes a selected-object-correspondence cluster representative value selection process.

This process is a process executed by the selected-object-correspondence cluster representative value selection unit 354 of the azimuth angle estimation object selection unit 307 illustrated in FIG. 14.

The selected-object-correspondence cluster representative value selection unit 354 acquires a representative value in the cluster that is set by the selected-object clustering processing unit 353.

The selected-object-correspondence cluster representative value selection unit 354 acquires a representative value of a size, (a speed and a distance), or the like of the cluster that is set by the selected-object clustering processing unit 353. This representative value is used to determine what type of object the cluster corresponds to.

(Steps S205 to S206)

Next, the azimuth angle estimation object selection unit 307 executes an azimuth angle estimation cluster selection process in step S205, and generates an azimuth angle estimation object selection speed-range map in step S206.

These processes are processes executed by the azimuth angle estimation cluster selection unit 355 of the azimuth angle estimation object selection unit 307 illustrated in FIG. 14.

The azimuth angle estimation cluster selection unit 355 selects, as the azimuth angle estimation target region (cluster), all or some of clusters that are set by the clustering processing unit 353 on the basis of the selected-object-correspondence feature amount, and generates a speed-range map indicating the azimuth angle estimation target region (cluster), that is, the “azimuth angle estimation object selection speed-range maps 91-1 to n”.

The generated map is inputted to the next selected-object-limited azimuth angle estimation unit 308.

The selected-object-limited azimuth angle estimation unit 308 is inputted with the “azimuth angle estimation object selection speed-range maps 91-1 to n”, refers to azimuth angle estimation target cluster selection information of the “azimuth angle estimation object selection speed-range maps 91-1 to n”, and executes the azimuth angle estimation process for only the selected cluster region.

By performing azimuth angle estimation of only a limited region corresponding to the selected object in this manner, it is possible to efficiently perform azimuth angle estimation in a short time.

### 5. About Generation Processing Example for Azimuth Angle Estimation Object Selection Speed-Range Map in Case where Azimuth Angle Estimation Process Target Object is Vehicle

Next, a description is given to a generation processing example for an azimuth angle estimation object selection speed-range map in case where an azimuth angle estimation process target object is a vehicle.

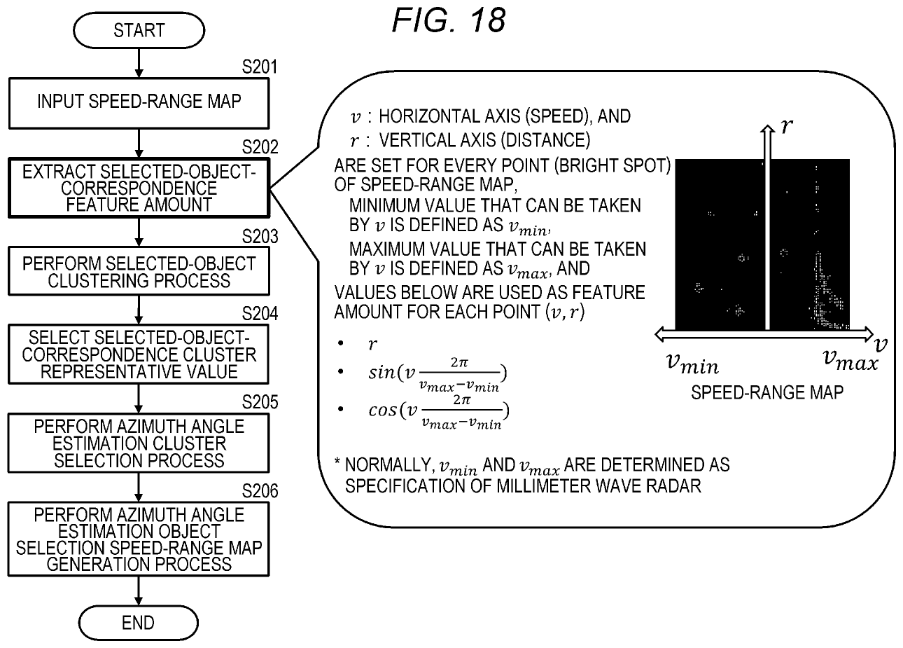

Hereinafter, with reference to FIGS. 18 to 21, a description is given to a generation processing example for an azimuth angle estimation object selection speed-range map in a case where an azimuth angle estimation process target object is a “vehicle” in the second embodiment described above.

Hereinafter, a description is given to a specific processing example of the following individual steps in a case where the azimuth angle estimation process target object is a vehicle in a case where the processing according to the flow described with reference to FIG. 17 is performed.

(1) Selected-object-correspondence feature amount extraction process in step S202 (FIG. 18)

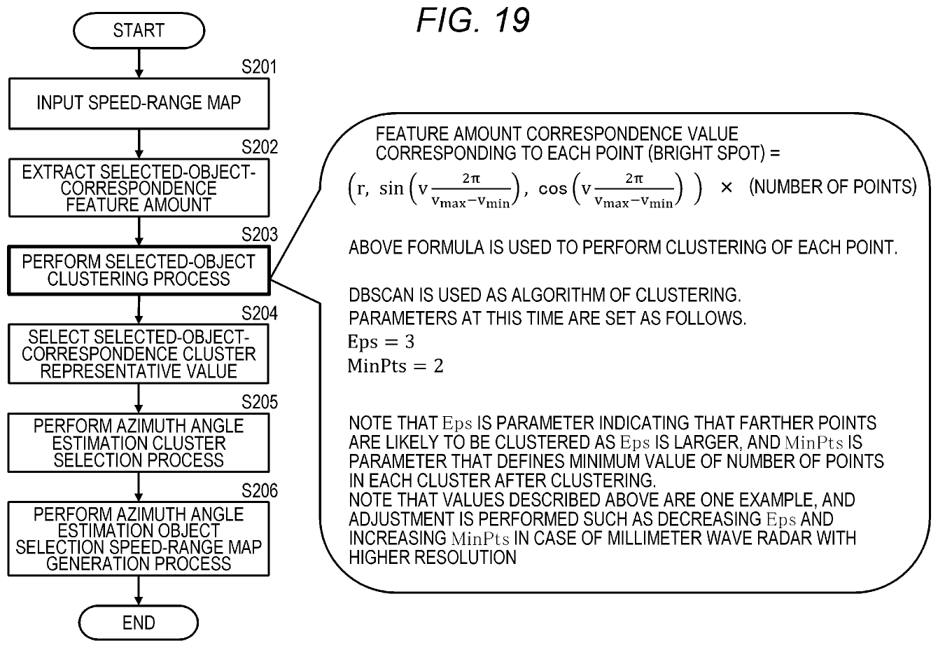

(2) Selected-object clustering process in step S203 (FIG. 19)

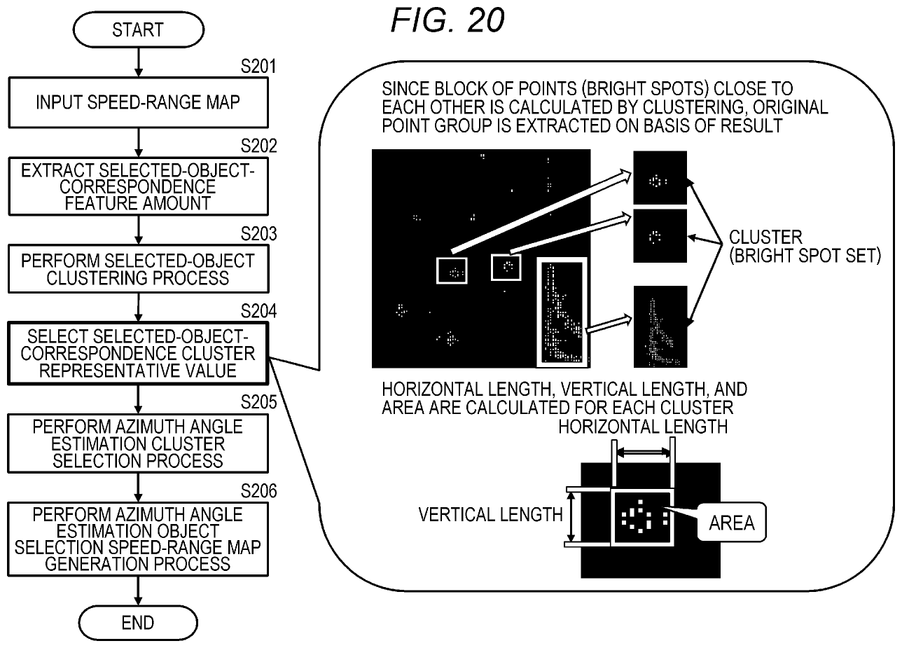

(3) Selected-object-correspondence cluster representative value selection process in step S204 (FIG. 20)

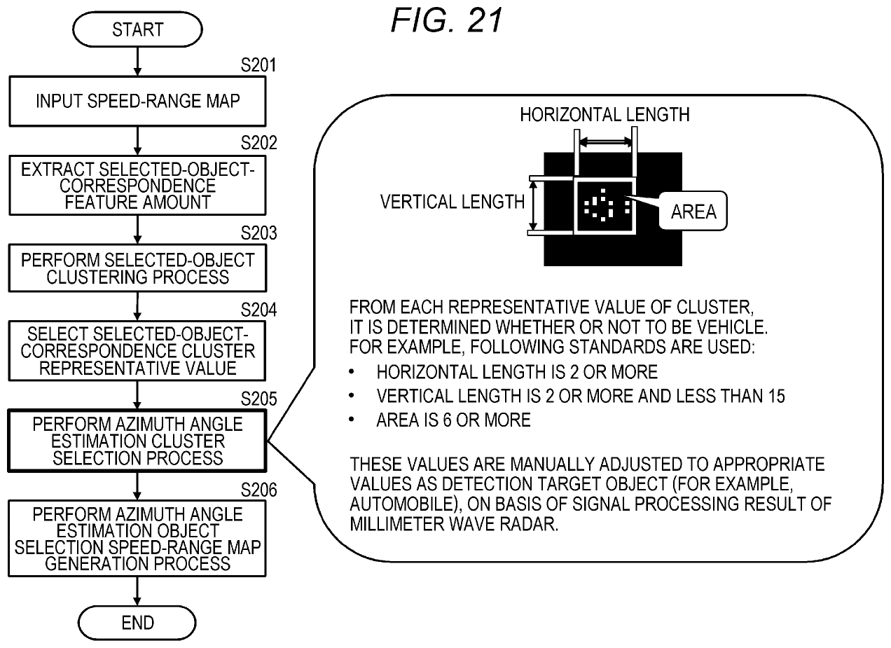

(4) Azimuth angle estimation cluster selection process in step S205 (FIG. 21)

First, with reference to FIG. 18, a description is given to the selected-object-correspondence feature amount extraction process in step S202 in a case where the azimuth angle estimation process target object is a vehicle.

As described above, in step S202, the azimuth angle estimation object selection unit 307 executes the selected-object-correspondence feature amount extraction process from each of the speed-range maps 51-1 to n.

This process is a process executed by the selected-object-correspondence feature amount extraction unit 352 of the azimuth angle estimation object selection unit 307 illustrated in FIG. 14.

The selected-object-correspondence feature amount extraction unit 352 extracts, from the speed-range map, a feature amount effective for selecting a region (pixel region) of a specific object that should be subjected to azimuth angle estimation, in this example, a vehicle.

With reference to FIG. 18, a description will be given to the selected-object-correspondence feature amount extraction process in step S202 in a case where the azimuth angle estimation process target object is a vehicle.

As illustrated in FIG. 18, the selected-object-correspondence feature amount extraction unit 352 of the azimuth angle estimation object selection unit 307 illustrated in FIG. 14 acquires the following individual parameters for every point (bright spot) of the speed-range map.

Speed (v)

Distance (r)

Note that a minimum value of the speed is defined as vmin, and a maximum value is defined as vmax.

These vmin and vmax are determined on the basis of specifications of the millimeter wave radar.

The selected-object-correspondence feature amount extraction unit 352 extracts the following feature amounts a to c as a feature amount of each bright spot, on the basis of parameters (a speed (v) and a distance (r)) acquired from every point (bright spot) of the speed-range map.

(a) distance (r)

(b) sin(v((2π)/(vmax−vmin))

(c) cos(v((2π)/(vmax−vmin))

As described above, in the selected-object-correspondence feature amount extraction process in step S202 in a case where the azimuth angle estimation process target object is a vehicle, the selected-object-correspondence feature amount extraction unit 352 executes a process of extracting the feature amounts of (a) to (c) described above in units of points (bright spots) of the speed-range map.

Next, with reference to FIG. 19, a description is given to the selected-object clustering process in step S203 in a case where the azimuth angle estimation process target object is a vehicle.

As described above, the azimuth angle estimation object selection unit 307 executes the selected-object clustering process in step S203.

This process is a process executed by the selected-object clustering processing unit 353 of the azimuth angle estimation object selection unit 307 illustrated in FIG. 14.

The selected-object clustering processing unit 353 applies each of the speed-range maps 51-1 to n and a selected-object-correspondence feature amount extracted from each map, which are inputted from the selected-object-correspondence feature amount extraction unit 352, to perform clustering on bright spots of each of the speed-range maps 51-1 to n.

Specifically, in this example, a clustering process is executed, which is for setting, as an azimuth angle estimation cluster, a region having a feature amount effective for selecting a region (pixel region) of a specific object that should be subjected to azimuth angle estimation, for example, a vehicle.

With reference to FIG. 19, a specific processing example will be described.

The selected-object clustering processing unit 353 calculates a feature amount correspondence value of each point (bright spot) of the speed-range map by the following formula.

Feature amount correspondence value=(r,sin(v((2π)/(vmax−vmin)),cos(v((2π)/(vmax−vmin)))×(number of points)

Clustering of each point is executed using the feature amount correspondence value calculated according to the formula described above.

Note that, as the clustering algorithm, density-based spatial clustering of applications with noise (DBSCAN) is applied.

As the parameters Eps and MinPts at the time of DBSCAN execution, the following setting, for example,

Eps=3,

MinPts=2

is used.

Note that Eps is a parameter indicating that farther points are likely to be clustered as Eps is larger, and MinPts is a parameter that defines a minimum value of the number of points in each cluster after clustering.

Note that the parameter setting value described above is one example, and it is preferable to perform adjustment such as decreasing Eps and increasing MinPts in a case of a millimeter wave radar with higher resolution.

Next, with reference to FIG. 20, a description is given to the selected-object-correspondence cluster representative value selection process in step S204 in a case where the azimuth angle estimation process target object is a vehicle.

As described above, in step S204, the azimuth angle estimation object selection unit 307 executes the selected-object-correspondence cluster representative value selection process.

This process is a process executed by the selected-object-correspondence cluster representative value selection unit 354 of the azimuth angle estimation object selection unit 307 illustrated in FIG. 14.

The selected-object-correspondence cluster representative value selection unit 354 acquires a representative value in the cluster that is set by the selected-object clustering processing unit 353.

The selected-object-correspondence cluster representative value selection unit 354 acquires a representative value of a size, (a speed and a distance), or the like of the cluster that is set by the selected-object clustering processing unit 353. This representative value is used to determine what type of object the cluster corresponds to.

With reference to FIG. 20, a description is given to the selected-object-correspondence cluster representative value selection process in step S204 in a case where the azimuth angle estimation process target object is a vehicle.

As illustrated in FIG. 20, the selected-object-correspondence cluster representative value selection unit 354 extracts a cluster (bright spot set) that is set by the selected-object clustering processing unit 353.

Next, the selected-object-correspondence cluster representative value selection unit 354 acquires, as a representative value, the following individual values in units of clusters:

(a) a horizontal length of the cluster,

(b) a vertical length of the cluster, and

(c) an area of cluster.

This example is an example in which a cluster size is acquired as a cluster representative value.

Note that this example is one example, and a configuration may be adopted in which, in addition to this, for example, a representative value of (a speed and a distance) or the like of the like in the cluster is acquired.

Next, with reference to FIG. 21, a description is given to the azimuth angle estimation cluster selection process in step S205 in a case where the azimuth angle estimation process target object is a vehicle.

As described above, the azimuth angle estimation object selection unit 307 executes the azimuth angle estimation cluster selection process in step S205.

This process is a process executed by the azimuth angle estimation cluster selection unit 355 of the azimuth angle estimation object selection unit 307 illustrated in FIG. 14.

The azimuth angle estimation cluster selection unit 355 selects, as the azimuth angle estimation target region (cluster), all or some of clusters that are set by the clustering processing unit 353 on the basis of the selected-object-correspondence feature amount, and generates a speed-range map indicating the azimuth angle estimation target region (cluster), that is, the “azimuth angle estimation object selection speed-range maps 91-1 to n”.

With reference to FIG. 21, a description is given to the azimuth angle estimation cluster selection process in step S205 in a case where the azimuth angle estimation process target object is a vehicle.

As illustrated in FIG. 21, the azimuth angle estimation cluster selection unit 355 uses the cluster representative value determined in step S204, that is, the following cluster representative value, to determine whether or not the cluster is a cluster corresponding to a vehicle:

(a) a horizontal length of the cluster,

(b) a vertical length of the cluster, and

(c) an area of cluster.

For example, if the cluster satisfies all of following conditions,

(a) horizontal length of cluster≥2 (m),

(b) 15>vertical length of cluster≥2 (m), and

(c) area of cluster≥6 (m),

it is determined that the cluster is a cluster corresponding to a vehicle.

Note that the conditions described above can be set by a user, and the user preferably adjusts to an optimum value with reference to a processing result of the signal processing device 300.

### 6. Summary of Configuration of Present Disclosure

The embodiments of the present disclosure have been described in detail with reference to the specific embodiments. However, it is obvious that those skilled in the art can make modifications and substitutions of the embodiments without departing from the scope of the present disclosure. In other words, the present invention has been disclosed in the form of exemplification, and should not be construed as limiting. In order to determine the scope of the present disclosure, the section of the claims should be taken into consideration.

Note that the technology disclosed in this specification can have the following configurations.

(1) A signal processing device including:

an azimuth angle estimation region selection unit configured to be inputted with a speed-range map indicating a distance and a relative speed of an object having reflected a radar wave, and select an azimuth angle estimation target region from the inputted speed-range map; and

an azimuth angle estimation unit configured to execute azimuth angle estimation for a selected region selected by the azimuth angle estimation region selection unit.

(2) The signal processing device according to (1), in which

the azimuth angle estimation region selection unit

detects, from the speed-range map, a cluster that is an aggregate of bright spots, the cluster satisfying a predetermined condition, and selects the detected cluster as an azimuth angle estimation target region.

(3) The signal processing device according to (1) or (2), in which

the azimuth angle estimation region selection unit

detects, from the speed-range map, a cluster that is an aggregate of bright spots of a prescribed number or more and a prescribed density or more, and selects the detected cluster as the azimuth angle estimation target region.

(4) The signal processing device according to any one of (1) to (3), in which

the azimuth angle estimation region selection unit

detects, from the speed-range map, a cluster that is an aggregate of bright spots, the cluster being estimated to correspond to a specific object type, and selects the detected cluster as the azimuth angle estimation target region.

(5) The signal processing device according to (4), in which the specific object type is at least one of a vehicle, a person, or a building.

(6) The signal processing device according to any one of (1) to (5), in which

the azimuth angle estimation unit

executes azimuth angle estimation for only a selected region selected by the azimuth angle estimation region selection unit, and generates an azimuth-range map indicating a distance and an azimuth angle of an object having reflected a radar wave.

(7) The signal processing device according to any one of (1) to (6), in which

the azimuth angle estimation region selection unit

generates a speed-range map clearly indicating the azimuth angle estimation target region, and outputs the speed-range map to the selected-region-limited azimuth angle estimation unit, and

the azimuth angle estimation unit

uses the speed-range map in which the azimuth angle estimation target region is clearly indicated, to execute azimuth angle estimation for only the selected region.

(8) The signal processing device according to any one of (1) to (7), in which

the azimuth angle estimation unit

executes azimuth angle estimation for a bright spot in a selected region selected by the azimuth angle estimation region selection unit.

(9) The signal processing device according to any one of (1) to (8), in which

the azimuth angle estimation region selection unit includes:

a feature amount extraction unit configured to extract a feature amount from the speed-range map; and

a clustering processing unit configured to detect, from the speed-range map, a cluster that is an aggregate of bright spots, the cluster satisfying a predetermined condition, on the basis of the feature amount.

(10) The signal processing device according to (9), in which

the feature amount extraction unit

extracts, from the speed-range map, a feature amount to be used to detect a cluster that is an aggregate of bright spots of a prescribed number or more and a prescribed density or more.

(11) The signal processing device according to (9), in which

the feature amount extraction unit

extracts, from the speed-range map, a feature amount to be used to detect a cluster that is an aggregate of bright spots, the cluster corresponding to an object of a predetermined specific type.

(12) The signal processing device according to any one of (9) to (11), in which

the azimuth angle estimation region selection unit further includes:

a cluster representative value selection unit configured to select a cluster representative value from a cluster that is set by the clustering processing unit.

(13) The signal processing device according to any one of (9) to (12), in which

the azimuth angle estimation region selection unit further includes:

an azimuth angle estimation cluster selection unit configured to generate a speed-range map clearly indicating a cluster that is the azimuth angle estimation target region, and output the speed-range map to the selected-region-limited azimuth angle estimation unit.

(14) The signal processing device according to any one of (1) to (13), further including:

a detection object analysis unit configured to be inputted with the speed-range map and an azimuth-range map, and to execute object analysis, the azimuth-range map being generated by the azimuth angle estimation unit and indicating a distance and an azimuth angle of an object.

(15) The signal processing device according to any one of (1) to (14), in which the speed-range map includes a plurality of maps generated by fast Fourier transform using reception signals of a plurality of radar wave receiving units.

(16) A signal processing method to be executed in a signal processing device, the signal processing method being for execution of:

an azimuth angle estimation region selection step, by an azimuth angle estimation region selection unit, of being inputted with a speed-range map indicating a distance and a relative speed of an object having reflected a radar wave, and selecting an azimuth angle estimation target region from the inputted speed-range map; and

an azimuth angle estimation step, by an azimuth angle estimation unit, of executing azimuth angle estimation for a selected region selected in the azimuth angle estimation region selection step.

(17) A program for causing a signal processing device to execute signal processing, the program causing execution of:

an azimuth angle estimation region selection step of causing an azimuth angle estimation region selection unit to be inputted with a speed-range map indicating a distance and a relative speed of an object having reflected a radar wave, and to select an azimuth angle estimation target region from the inputted speed-range map; and

an azimuth angle estimation step of causing an azimuth angle estimation unit to execute azimuth angle estimation for a selected region selected in the azimuth angle estimation region selection step.

The series of processing described in the specification can be executed by hardware, software, or a combined configuration of both. In a case of executing processing by software, a program recording a processing sequence can be installed and executed in a memory in a computer incorporated in dedicated hardware, or a program can be installed and executed in a general-purpose computer capable of executing various types of processing. For example, the program can be recorded in advance on a recording medium. The program can be installed from a recording medium to a computer, or can be received via a network such as a local area network (LAN) or the Internet, and installed in a recording medium such as an incorporated hard disk.

Note that the various processes described in the specification may be executed not only in a chronological order in accordance with the description, but may also be executed in parallel or individually depending on processing capability of a device that executes the processing or depending on the necessity. Furthermore, a system in this specification is a logical set configuration of a plurality of devices, and is not limited to one in which a device of each configuration is in a same casing.

### INDUSTRIAL APPLICABILITY

As described above, according to a configuration of an embodiment of the present disclosure, an apparatus and a method for performing azimuth angle estimation are realized in which an object region or only an object region of a specific type is used as an azimuth angle estimation target region.

Specifically, for example, there are provided: an azimuth angle estimation region selection unit configured to be inputted with a speed-range map indicating a distance and a relative speed of an object having reflected a radar wave, and select an azimuth angle estimation target region from the inputted speed-range map; and an azimuth angle estimation unit configured to execute azimuth angle estimation for only a selected region. The azimuth angle estimation region selection unit detects, from the speed-range map, a cluster that is an aggregate of bright spots and satisfies a predetermined condition, and selects the detected cluster as the azimuth angle estimation target region. For example, an aggregate of bright spots of a prescribed number or more and a prescribed density or more or a cluster corresponding to a specific object type is selected as the azimuth angle estimation target region.

According to configuration, an apparatus and a method for performing azimuth angle estimation are realized in which an object region or only an object region of a specific type is used as the azimuth angle estimation target region.

### REFERENCE SIGNS LIST

20 Detection target object
100 Signal processing device (millimeter wave radar device)
101 Transmission wave generation unit (synthesizer)
102 Transmission antenna
103 Reception antenna
104 Mixer
105 AD converter
106 FFT
107 Azimuth angle estimation unit
108 Detection object analysis unit
200 Signal processing device (millimeter wave radar device)
201 Transmission wave generation unit (synthesizer)
202 Transmission antenna
203 Reception antenna
204 Mixer
205 AD converter
206 FFT
207 Azimuth angle estimation region selection unit
208 Selected-region-limited azimuth angle estimation unit
209 Detection object analysis unit
251 Speed-range map input unit
252 Feature amount extraction unit
253 Clustering processing unit
254 Cluster representative value selection unit
255 Azimuth angle estimation cluster selection unit
300 Signal processing device (millimeter wave radar device)
301 Transmission wave generation unit (synthesizer)
302 Transmission antenna
303 Reception antenna
304 Mixer
305 AD converter
306 FFT
307 Azimuth angle estimation region selection unit
308 Selected-region-limited azimuth angle estimation unit
309 Detection object analysis unit
351 Speed-range map input unit
352 Selected-object-correspondence feature amount extraction unit
353 Selected-object clustering processing unit
354 Selected-object-correspondence cluster representative value selection unit
355 Azimuth angle estimation cluster selection unit

1. A signal processing device comprising:
an azimuth angle estimation region selection unit configured to be inputted with a speed-range map indicating a distance and a relative speed of an object having reflected a radar wave, and select an azimuth angle estimation target region from the inputted speed-range map; and
an azimuth angle estimation unit configured to execute azimuth angle estimation for a selected region selected by the azimuth angle estimation region selection unit.

2. The signal processing device according to claim 1, wherein
the azimuth angle estimation region selection unit
detects, from the speed-range map, a cluster that is an aggregate of bright spots, the cluster satisfying a predetermined condition, and selects the detected cluster as an azimuth angle estimation target region.

3. The signal processing device according to claim 1, wherein
the azimuth angle estimation region selection unit
detects, from the speed-range map, a cluster that is an aggregate of bright spots of a prescribed number or more and a prescribed density or more, and selects the detected cluster as the azimuth angle estimation target region.

4. The signal processing device according to claim 1, wherein
the azimuth angle estimation region selection unit
detects, from the speed-range map a cluster that is an aggregate of bright spots, the cluster being estimated to correspond to a specific object type, and selects the detected cluster as the azimuth angle estimation target region.

5. The signal processing device according to claim 4, wherein the specific object type includes at least one of a vehicle, a person, or a building.

6. The signal processing device according to claim 1, wherein
the azimuth angle estimation unit
executes azimuth angle estimation for only a selected region selected by the azimuth angle estimation region selection unit, and generates an azimuth-range map indicating a distance and an azimuth angle of an object having reflected a radar wave.

7. The signal processing device according to claim 1, wherein
the azimuth angle estimation region selection unit
generates a speed-range map clearly indicating the azimuth angle estimation target region, and outputs the speed-range map to the selected-region-limited azimuth angle estimation unit, and
the azimuth angle estimation unit
uses the speed-range map in which the azimuth angle estimation target region is clearly indicated, to execute azimuth angle estimation for only the selected region.

8. The signal processing device according to claim 1, wherein
the azimuth angle estimation unit
executes azimuth angle estimation for a bright spot in a selected region selected by the azimuth angle estimation region selection unit.

9. The signal processing device according to claim 1, wherein
the azimuth angle estimation region selection unit includes:
a feature amount extraction unit configured to extract a feature amount from the speed-range map; and
a clustering processing unit configured to detect, from the speed-range map, a cluster that is an aggregate of bright spots, the cluster satisfying a predetermined condition, on a basis of the feature amount.

10. The signal processing device according to claim 9, wherein
the feature amount extraction unit
extracts, from the speed-range map, a feature amount to be used to detect a cluster that is an aggregate of bright spots of a prescribed number or more and a prescribed density or more.

11. The signal processing device according to claim 9, wherein
the feature amount extraction unit
extracts, from the speed-range map, a feature amount to be used to detect a cluster that is an aggregate of bright spots, the cluster corresponding to an object of a predetermined specific type.

12. The signal processing device according to claim 9, wherein
the azimuth angle estimation region selection unit further includes:
a cluster representative value selection unit configured to select a cluster representative value from a cluster that is set by the clustering processing unit.

13. The signal processing device according to claim 9, wherein
the azimuth angle estimation region selection unit further includes:
an azimuth angle estimation cluster selection unit configured to generate a speed-range map clearly indicating a cluster that is the azimuth angle estimation target region, and output the speed-range map to the selected-region-limited azimuth angle estimation unit.

14. The signal processing device according to claim 1, further comprising:
a detection object analysis unit configured to be inputted with the speed-range map and an azimuth-range map, and to execute object analysis, the azimuth-range map being generated by the azimuth angle estimation unit and indicating a distance and an azimuth angle of an object.

15. The signal processing device according to claim 1, wherein the speed-range map includes a plurality of maps generated by fast Fourier transform using reception signals of a plurality of radar wave receiving units.

16. A signal processing method to be executed in a signal processing device, the signal processing method being for execution of:
an azimuth angle estimation region selection step, by an azimuth angle estimation region selection unit, of being inputted with a speed-range map indicating a distance and a relative speed of an object having reflected a radar wave, and selecting an azimuth angle estimation target region from the inputted speed-range map; and
an azimuth angle estimation step, by an azimuth angle estimation unit, of executing azimuth angle estimation for a selected region selected in the azimuth angle estimation region selection step.

17. A program for causing a signal processing device to execute signal processing, the program causing execution of:
an azimuth angle estimation region selection step of causing an azimuth angle estimation region selection unit to be inputted with a speed-range map indicating a distance and a relative speed of an object having reflected a radar wave, and to select an azimuth angle estimation target region from the inputted speed-range map; and
an azimuth angle estimation step of causing an azimuth angle estimation unit to execute azimuth angle estimation for a selected region selected in the azimuth angle estimation region selection step.
